(19) United States
(12) Patent Application Publication
(10) Pub. No.: US 2024/0323327 A1
(43) Pub. Date: Sep. 26, 2024

(54) PROJECTION SYSTEM, PROJECTION METHOD, NON-TRANSITORY COMPUTER-READABLE STORAGE MEDIUM STORING PROJECTION PROGRAM

(71) Applicant: SEIKO EPSON CORPORATION, Tokyo (JP)

(72) Inventor: Yuzo MURASAWA, Aoki-mura (JP)

(73) Assignee: SEIKO EPSON CORPORATION, Tokyo (JP)

(21) Appl. No.: 18/613,593

(22) Filed: Mar. 22, 2024

(30) Foreign Application Priority Data
Mar. 23, 2023 (JP) 2023-046393

(51) Int. Cl. H04N 9/31; G06F 3/16

(52) U.S. Cl. CPC H04N 9/3185; G06F 3/167

(57) ABSTRACT

A projection system includes a projector configured to project a projection image onto a projection target, a detector configured to detect voice of a user, and a controller configured to control the projector based on a command included in the voice detected by the detector. The controller executes a voice input mode for adjusting a shape of the projection image based on the command.

The present application is based on, and claims priority from JP Application Serial Number 2023-046393, filed Mar. 23, 2023, the disclosure of which is hereby incorporated by reference herein in its entirety.

### BACKGROUND

### 1. Technical Field

The present disclosure relates to a projection system, a projection method, and a non-transitory computer-readable storage medium storing a projection program.

### 2. Related Art

A video projection system including voice recognizing means is known. A video projection system described in JP-A-2002-94980 includes a video projector, voice recognizing means, and video correcting means. The video projector is configured by a liquid crystal projector that projects a video onto a projection surface. The voice recognizing means recognizes voice of a user and extracts a processing request to the video projector. The processing request to be extracted is a change request for changing a projecting direction of a video by the video projector. The video correcting means corrects distortion of the video according to a projecting direction of the video projector. The video projection system is an example of a projection system.

The video correcting means described in JP-A-2002-94980 is not adapted to the processing request extracted by the voice recognizing means. The video projection system does not have a function of correcting distortion of a video based on voice of a user.

### SUMMARY

According to an aspect of the present disclosure, there is provided a projection system including: a projector configured to project a projection image onto a projection target; a detector configured to detect voice of a user; and a control device configured to control the projector based on a command included in the voice detected by the detector. The control device executes a voice input mode for adjusting a shape of the projection image based on the command.

According to an aspect of the present disclosure, there is provided a projection method of a projection system that projects a projection image onto a projection target, the projection method including: executing a voice input mode for acquiring voice of a user; and adjusting a shape of the projection image based on a command included in the voice.

According to an aspect of the present disclosure, there is provided a non-transitory computer-readable storage medium storing a projection program, the projection program causing a controller to: execute a voice input mode for acquiring voice of a user; extract a command included in the voice; and adjust a shape of a projection image based on the extracted command.

### BRIEF DESCRIPTION OF THE DRAWINGS

FIG. 1 is a diagram showing a schematic configuration of a display system.

FIG. 2 is a diagram showing a block configuration of the display system.

FIG. 3 is a diagram showing a schematic configuration of a projecting unit.

FIG. 4 is a diagram showing a configuration of a management screen.

FIG. 5 is a diagram showing an example of a pattern image.

FIG. 6 is a diagram showing an example of the pattern image.

FIG. 7 is a diagram showing an example of the pattern image.

FIG. 8 is a diagram showing an example of the pattern image.

FIG. 9 is a diagram showing an example of the pattern image.

FIG. 10 is a diagram showing an example of the pattern image.

FIG. 11 is a partially enlarged diagram of the pattern image.

FIG. 12 is a partially enlarged diagram of the pattern image.

FIG. 13 is a partially enlarged diagram of the pattern image.

FIG. 14 is a partially enlarged diagram of the pattern image.

FIG. 15 is a partially enlarged diagram of the pattern image.

FIG. 16 is a partially enlarged diagram of the pattern image.

FIG. 17 is a diagram showing a control flow of the display system.

FIG. 18 is a diagram showing the control flow of the display system.

FIG. 19 is a diagram showing a schematic configuration of the display system.

FIG. 20 is a diagram showing a block configuration of the display system.

FIG. 21 is a diagram showing an example of a projection image projected onto a projection surface.

FIG. 22 is a diagram showing an example of the projection image projected onto the projection surface.

FIG. 23 is a diagram showing an example of the projection image projected onto the projection surface.

FIG. 24 is a diagram showing a schematic configuration of the display system.

FIG. 25 is a diagram showing a block configuration of the display system.

### DESCRIPTION OF EMBODIMENTS

### First Embodiment

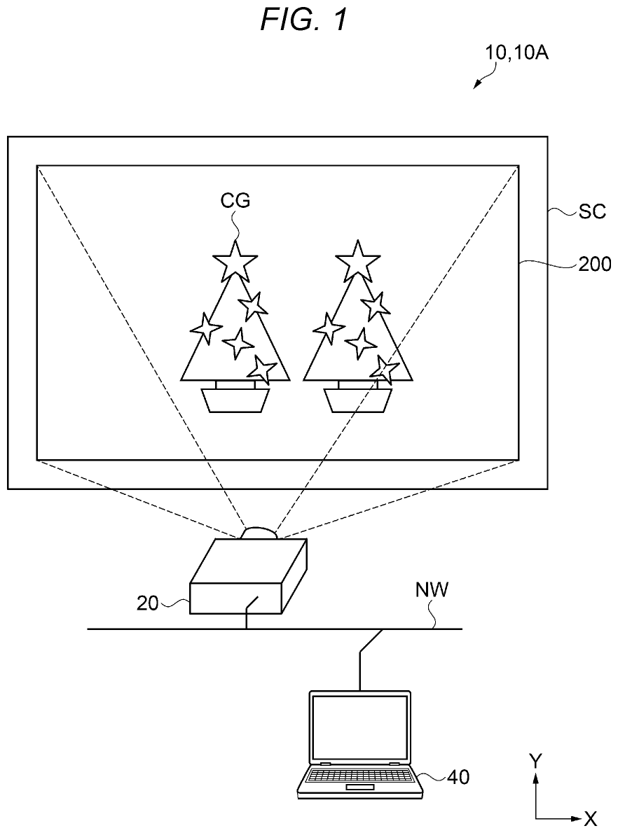

FIG. 1 shows a schematic configuration of a display system 10. FIG. 1 shows a schematic configuration of a first display system 10A in a first embodiment. The first display system 10A is an example of the display system 10. The first display system 10A includes a projector 20 and a display control device 40. The display system 10 corresponds to an example of the projection system.

The projector 20 projects various projection images 200 onto a projection surface SC. The projector 20 is communicably connected to the display control device 40. The projector 20 shown in FIG. 1 is communicably connected to the display control device 40 via a network NW. The projector 20 may be communicably connected to a not-illustrated external device. The projector 20 projects a projection image 200 onto the projection surface SC based on image data input from the display control device 40 or image data input from the external device. The image data causes the projector 20 to display a content image CG on at least a part of the projection image 200. The content image CG is a still image or a moving image. The projector 20 corresponds to an example of the projection device as a43 projector.

The projector 20 shown in FIG. 1 projects the projection image 200 including the content image CG onto the projection surface SC. The projector 20 acquires image data from the display control device 40 or the external device. The projector 20 projects the content image CG in the projection image 200 based on the image data. The projector 20 projects the content image CG in at least a part of the projection image 200 on the projection surface SC.

The display control device 40 generates correction data for correcting the projection image 200 projected by the projector 20. The display control device 40 is communicably connected to the projector 20. The display control device 40 transmits the image data, the correction data, and the like to the projector 20. The projector 20 projects the projection image 200 onto the projection surface SC based on the image data. The projector 20 corrects, based on the correction data, the projection image 200 to be projected onto the projection surface SC. The display control device 40 corresponds to an example of the control device as a controller. The display control device 40 is configured by a personal computer, a notebook personal computer, a tablet terminal, a smartphone, or the like. The display control device 40 shown in FIG. 1 is a notebook personal computer.

The projection surface SC displays the projection image 200 projected from the projector 20. The projection surface SC displays various projection images 200. The various projection images 200 include the content image CG or a pattern image 210 explained below. The projection surface SC is a surface of an object onto which the projection image 200 is projected. The projection surface SC may have a three-dimensional shape such as a surface having unevenness or a curved surface. The projection surface SC may be configured by a screen or the like. FIG. 1 shows an X axis and a Y axis. The X axis and the Y axis are axes on the projection surface SC orthogonal to each other. The projection surface SC corresponds to an example of the projection target.

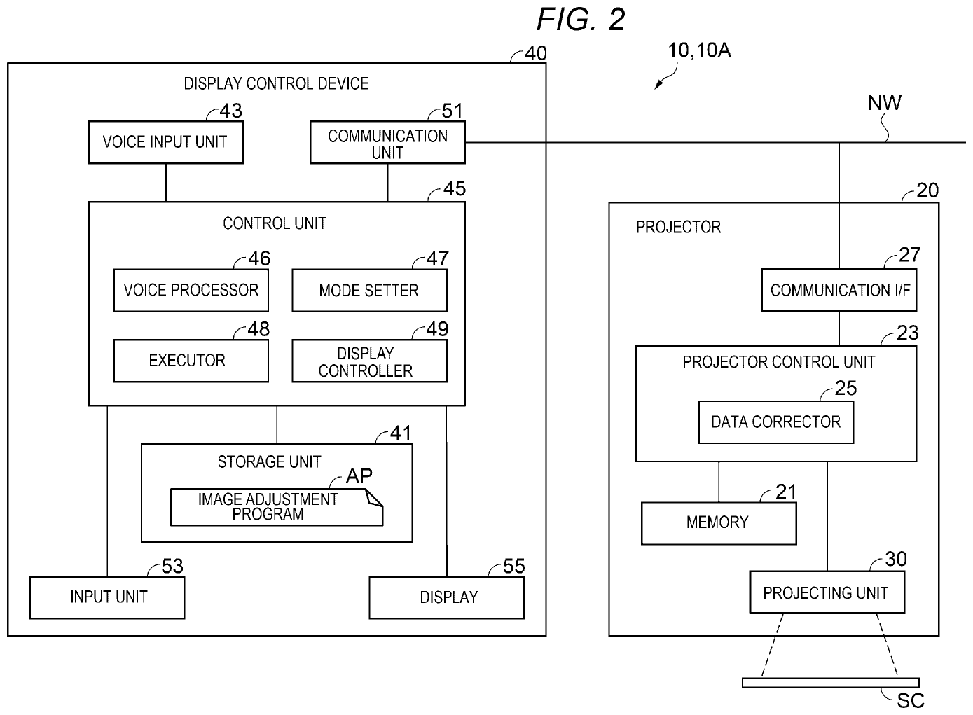

FIG. 2 shows a block configuration of the display system 10. FIG. 2 shows a block configuration of the first display system 10A. FIG. 2 shows the projector 20 and the display control device 40. FIG. 2 shows the projection screen SC onto which the projection image 200 is projected by the projector 20.

The projector 20 includes a memory 21, a projector control unit 23, a communication interface 27, and a projecting unit 30. In FIG. 2, interface is represented as I/F.

The memory 21 stores various data. The memory 21 stores OSD data. OSD is an abbreviation of on-screen display. The OSD data causes the projector 20 to display, in the projection image 200, an image for causing a user to perform various kinds of setting concerning the projector 20. The OSD data is stored in the memory 21 in advance. The memory 21 stores image data, correction data, and the like transmitted from the display control device 40. The memory 21 may store the image data and the like transmitted from the external device. The memory 21 stores various programs including a projector control program running on the projector control unit 23. The memory 21 is configured by a ROM (Read Only Memory), a RAM (Random Access Memory), and the like.

The projector control unit 23 is a projector controller that controls the projector 20. As an example, the projector control unit 23 is a processor including a CPU (Central Processing Unit). The projector control unit 23 is configured by one or a plurality of processors. The projector control unit 23 may include a semiconductor memory such as a RAM or a ROM. The semiconductor memory functions as a work area of the projector control unit 23. The projector control unit 23 executes the projector control program stored in the memory 21 to thereby function as a data corrector 25.

The data corrector 25 adjusts the OSD data and corrects image data and the like. The data corrector 25 adjusts pattern image data based on adjustment data transmitted from the display control device 40. The pattern image data is included in the OSD data. The data corrector 25 causes, using the pattern image data, the projecting unit 30 to project the projection image 200 including the pattern image 210. The data corrector 25 performs, on the image data and the like, various kinds of correction such as edge blending, geometrical distortion correction, and image quality adjustment. The data corrector 25 corrects the image data and the like using correction data stored in the memory 21. The data corrector 25 may divide the image data and the like for each of unit regions and perform the correction for each of the unit regions.

The communication interface 27 receives various data such as the image data and the correction data. The communication interface 27 is communicatively connected to the display control device 40, the external device, and the like. The communication interface 27 is connected to the display control device 40 and the like by wire or radio according to a predetermined communication protocol. The communication interface 27 includes, for example, a connection port for wired communication, an antenna for wireless communication, and an interface circuit. The communication interface 27 shown in FIG. 2 is communicatively connected to the display control device 40 and the like via the network NW. The communication interface 27 may be communicatively connected to the display control device 40 via an HDMI (High-Definition Multimedia Interface) cable or the like. HDMI is a registered trademark. The communication interface 27 receives the image data, the correction data, and the like from the display control device 40. The communication interface 27 receives the image data and the like from the external device. The communication interface 27 may transmit various data to the display control device 40 and the like.

The projecting unit 30 projects the projection image 200 onto the projection surface SC. The projecting unit 30 projects the projection image 200 onto the projection surface SC based on the control of the projector control unit 23. A schematic configuration of the projecting unit 30 is explained below.

The display control device 40 includes a storage unit 41, a voice input unit 43, a control unit 45, a communication unit 51, an input unit 53, and a display 55. The display control device 40 is communicatively connected to the projector 20 via the network NW.

The storage unit 41 stores various data, various control programs, and the like. The storage unit 41 stores image data, correction data, and the like generated by the control unit 45. The storage unit 41 stores a control program running on the control unit 45. The control programs stored by the storage unit 41 include an image adjustment program AP. The storage unit 41 is configured by a ROM, a RAM, and the like. The storage unit 41 is a nonvolatile readable medium readable by the control unit 45 explained below. The storage unit 41 may further include a magnetic storage device such as a HDD (Hard Disk Drive) and a semiconductor memory. The storage unit 41 corresponds to an example of the recording medium. Note that the recording medium may be distributed to the user separately from the projector 20.

The storage unit 41 stores content image data for causing the projector 20 to project the content image CG onto the projection surface SC. The content image data is a type of the image data. The content image data corresponds to an example of the content data. The storage unit 41 may store the content image data corrected by the correction data. The storage unit 41 stores content image data generated by the control unit 45 or the external device.

The voice input unit 43 receives input of various kinds of sound and detects voice of the user. The voice input unit 43 includes a built-in microphone and a voice processing circuit. The built-in microphone and the voice processing circuit are not illustrated. Various kinds of sound are input to the built-in microphone. Instead of the voice input unit 43 not including the built-in microphone, an external microphone may be connected to the voice input unit 43. The voice processing circuit detects voice of the user included in the sound. The voice processing circuit transmits the detected voice of the user to the control unit 45. The voice input unit 43 may transmit the sound input to the built-in microphone to the control unit 45. At this time, the control unit 45 functions as the voice processing circuit. The voice input unit 43 corresponds to an example of the detection device as a detector.

The control unit 45 is a controller that performs various kinds of processing. As an example, the control unit 45 is a processor including a CPU. The control unit 45 is configured by one or a plurality of processors. The control unit 45 may include a semiconductor memory such as a RAM or a ROM. The semiconductor memory functions as a work area of the control unit 45. The control unit 45 executes the control program stored in the storage unit 41 to thereby function as a functional unit. The control unit 45 corresponds to an example of the control device.

The control unit 45 causes the image adjustment program AP stored in the storage unit 41 to operate. The control unit 45 executes the image adjustment program AP to thereby function as a voice processor 46, a mode setter 47, an executor 48, and a display controller 49. The image adjustment program AP causes the display 55 to display a management screen 100. The image adjustment program AP causes the projector 20 to project the projection image 200 including the pattern image 210 onto the projection surface SC. The image adjustment program AP causes the projector 20 to project the pattern image 210. The user performs input operation to the management screen 100 to thereby adjust the shape of the pattern image 210. The user adjusts the shape of the pattern image 210 to thereby adjust the shape of the projection image 200. The adjusting the shape of the pattern image 210 corresponds to adjusting the shape of the projection image 200. The image adjustment program AP causes, based on the input operation by the user, the control unit 45 to generate adjustment data. The adjustment data is data for adjusting the pattern image 210. The image adjustment program AP corresponds to an example of the projection program.

The control unit 45 may execute the image adjustment program AP to thereby function as functional units other than the voice processor 46, the mode setter 47, the executor 48, and the display controller 49. The control unit 45 may execute the image adjustment program AP based on voice of the user input to the voice input unit 43. The control unit 45 is triggered by a start instruction included in the voice of the user to execute the image adjustment program AP.

The voice processor 46 extracts an instruction included in voice of the user. The instruction to be extracted is a selection instruction, a movement instruction, a movement cancellation instruction, an end instruction, or the like. The instruction corresponds to an example of the command. The voice processor 46 converts the extracted instruction into an instruction command. The instruction command is a command for causing the projector 20 to execute the extracted instruction. A part of the instruction command includes adjustment data. The adjustment data is data for adjusting the shape of the pattern image 210. The voice processor 46 transmits the instruction command to the executor 48 and the display controller 49. The voice processor 46 may receive sound input to the voice input unit 43. When receiving the sound, the voice processor 46 detects voice of the user included in the sound. The voice processor 46 functions as a voice processing circuit.

The mode setter 47 sets an input mode. The input mode is a mode that the user can execute when adjusting the shape of the pattern image 210. The input mode is a voice instruction mode or an operation instruction mode. The mode setter 47 sets the voice instruction mode as the input mode, whereby the voice processor 46 and the executor 48 become capable of executing the voice instruction mode. The mode setter 47 sets the operation instruction mode as the input mode, whereby the executor 48 becomes capable of executing the operation instruction mode.

The voice instruction mode is a mode for receiving the instruction extracted by the voice processor 46. The executor 48 controls the pattern image 210 based on the instruction command transmitted from the voice processor 46. The executor 48 controls the pattern image 210 by adjusting the shape of the projection image 200. The voice instruction mode becomes executable, whereby the user can adjust the shape of the projection image 200 in a position away from the display control device 40. The user can adjust the shape of the projection image 200 without checking the display 55 of the display control device 40. The voice instruction mode corresponds to an example of the voice input mode.

The operation instruction mode is a mode for receiving an instruction based on input operation input to the input unit 53. The executor 48 controls the pattern image 210 based on the instruction command transmitted from the input unit 53. The executor 48 controls the pattern image 210 to thereby adjust the shape of the projection image 200.

When the mode setter 47 sets the voice instruction mode as the input mode, the executor 48 may or may not receive the instruction command transmitted from the input unit 53. The executor 48 preferably receives the instruction command transmitted from the input unit 53. The user can control the pattern image 210 with an instruction by voice and an instruction input by using the input unit 53.

When the mode setter 47 sets the operation instruction mode as the input mode, the executor 48 does not receive the instruction command transmitted from the voice processor 46. The executor 48 does not receive the instruction command based on the instruction included in the voice, whereby the user can prevent transmission of an unintended instruction.

The mode setter 47 sets the input mode under predetermined setting conditions. The setting conditions are an instruction by voice of the user, a predetermined instruction command input to the input unit 53, and the like. When the image adjustment program AP is executed, the mode setter 47 may set the voice instruction mode as an initial condition of the input mode. When the control unit 45 is triggered by a start instruction by voice to start the image adjustment program AP, the mode setter 47 may set the voice instruction mode as the input mode. The mode setter 47 sets the input mode at various timings.

When the projector 20 projects the pattern image 210 onto the projection surface SC, the mode setter 47 preferably sets the voice input mode as the input mode. When the image adjustment program AP is executed, the control unit 45 causes the projector 20 to project the projection image 200 including the pattern image 210. When the projector 20 projects the projection image 200 including the pattern image 210, the mode setter 47 sets the input mode to the voice instruction mode. The display control device 40 becomes capable of executing the voice instruction mode. When the projection image 200 including the pattern image 210 is projected onto the projection surface SC, the user can immediately perform an instruction by voice.

The executor 48 causes the projector 20 to project the projection image 200 including the pattern image 210. When the image adjustment program AP is executed, the executor 48 causes the projector 20 to project the projection image 200 including the pattern image 210. When the pattern image 210 is projected onto the projection surface SC, the user becomes capable of adjusting the shape of the pattern image 210 projected by the projector 20. The user becomes capable of adjusting the shape of the pattern image 210 by performing input operation to the management screen 100.

The executor 48 causes the projector 20 to project the projection image 200 including the content image CG onto the projection surface SC. The executor 48 reads the content image data from the storage unit 41. The executor 48 transmits the content image data to the communication unit 51. The communication unit 51 transmits the content image data to the projector 20. The projector 20 projects the projection image 200 including the content image CG onto the projection surface SC using the content image data. The executor 48 transmits the content image data to the projector 20 to thereby cause the projector 20 to project the content imageCG.

When causing the projector 20 to project the projection image 200 including the content image CG, the executor 48 may or may not cause the projector 20 to project the pattern image 210. When the projection image 200 including the content image CG is projected, the executor 48 preferably does not cause the projector 20 to project the pattern image 210. When projecting the projection image 200 including the content image CG, the projector 20 preferably does not project the pattern image 210. That is, the display control device 40 preferably does not cause the projector 20 to project the pattern image 210 in a period in which the content image CG is projected by the projector 20. In this case, even if an instruction for adjusting the shape of the projection image 200 is input to the voice input unit 43, the display control device 40 preferably does not cause the projector 20 to project the pattern image 210 onto the projection surface SC. In other words, the display control device 40 preferably does not execute the voice instruction mode in the period in which the content image CG is projected by the projector 20. The projector 20 does not simultaneously project the pattern image 210 and the content image CG, whereby the user can easily visually recognize the pattern image 210.

The executor 48 performs various kinds of control based on the instruction command. The executor 48 acquires the instruction command transmitted from the voice processor 46 or the input unit 53. When the mode setter 47 sets the voice instruction mode as the input mode, the executor 48 receives the instruction command transmitted from the voice processor 46. When the mode setter 47 sets the operation instruction mode as the input mode, the executor 48 receives the instruction command transmitted from the input unit 53. The executor 48 transmits the received instruction command to the projector 20 via the communication unit 51.

The executor 48 transmits the instruction command or the like to the projector 20 to thereby control the pattern image 210 projected onto the projection surface SC. As an example, the executor 48 controls the pattern image 210 to thereby adjust the shape of the pattern image 210. The executor 48 transmits the instruction command to the display controller 49. The executor 48 transmits the instruction command to the display controller 49 to thereby control a preview image 143 displayed on the display 55. The preview image 143 is explained below,

The executor 48 generates correction data for correcting the content image CG. The executor 48 may transmit the correction data to the projector 20 via the communication unit 51. The executor 48 may transmit the correction data to the storage unit 41. The storage unit 41 stores the received correction data.

The correction data is data for causing the data corrector 25 to perform various kinds of correction such as geometrical distortion correction and edge blending. The geometrical distortion correction is processing for correcting distortion of the projection image 200. The distortion of the projection image 200 occurs when the projection surface SC is a curved surface or when unevenness is present on the projection surface SC. The distortion of the projection image 200 occurs when the projector 20 projects the projection image 200 from a position other than the front of the projection surface SC. The correction data is generated based on an instruction of the user. The correction data corrects distortion of the projection image 200 projected onto the projection surface SC.

The display controller 49 generates screen data to be displayed on the display 55. The display controller 49 transmits the screen data to the display 55. The display controller 49 transmits the screen data to the display 55 to thereby cause the display 55 to display the management screen 100. The management screen 100 includes the preview image 143. The screen data includes the instruction command transmitted from the executor 48. When receiving the instruction command, the display controller 49 transmits the screen data including the instruction command to the display 55. The display controller 49 controls the preview image 143 based on the instruction command.

The communication unit 51 is communicatively connected to the projector 20, the external device, and the like. The communication unit 51 is connected to the projector 20 and the like by wire or radio according to a predetermined communication protocol. The communication unit 51 shown in FIG. 2 is communicably connected to the communication interface 27 of the projector 20 via the network NW. The communication unit 51 includes, for example, a connection port for wired communication, an antenna for wireless communication, and an interface circuit. The communication unit 51 receives the instruction command and the like from the executor 48. The communication unit 51 transmits the received instruction command and the like to the projector 20. The communication unit 51 receives the correction data from the executor 48. The communication unit 51 transmits the received correction data to the projector 20. The communication unit 51 may receive various data transmitted from the projector 20.

The communication unit 51 transmits the content image data stored in the storage unit 41 to the projector 20. The communication unit 51 transmits the content image data to thereby supply the content image data to the projector 20. The communication unit 51 may transmit the content image data generated by the control unit 45 to the projector 20. The communication unit 51 corresponds to an example of the supply device.

The input unit 53 receives input operation by the user. The input unit 53 receives an instruction of the user input by the input operation by the user. The input unit 53 generates an instruction command based on the instruction of the user. The input unit 53 transmits the instruction command to the control unit 45. The input unit 53 receives a plurality of instructions. The input unit 53 generates an instruction command corresponding to each of the plurality of instructions. At least a part of the instructions input to the input unit 53 is the same as the instruction extracted by the voice processor 46. The input unit 53 is configured by a keyboard, a touch pad, or the like. The input unit 53 may include an external mouse and an external keyboard. The input unit 53 receives input operation of the user other than the voice.

The display 55 displays a screen such as the management screen 100 based on the screen data transmitted from the display controller 49. The display 55 is configured by a display panel such as a liquid crystal panel or an organic EL (electro-luminescence) panel. The display 55 may be configured by an external display panel connected to the display control device 40. The display 55 may have a touch panel function. When the display 55 has the touch panel function, the display 55 functions as the input unit 53.

The first display system 10A includes the projector 20 that projects the projection image 200 onto the projection surface SC, the voice input unit 43 that detects voice of the user, and the display control device 40 that controls the projector 20 based on an instruction included in the voice detected by the voice input unit 43. The display control device 40 is capable of executing the voice instruction mode for adjusting the shape of the projection image 200 based on the instruction.

The user becomes capable of adjusting the shape of the projection image 200 with voice instruction input.

The display control device 40 includes the communication unit 51 that supplies the content image data corresponding to the content image CG to the projector 20. The display control device 40 preferably does not cause the projector 20 to display the pattern image 210 onto the projection surface SC in a period in which the projection image 200 including the content image CG is projected by the projector 20.

The display control device 40 can prevent the projection image 200 including the content image CG and the pattern image 210 from being projected onto the projection surface SC. The user can easily visually recognize the content image CG or the pattern image 210.

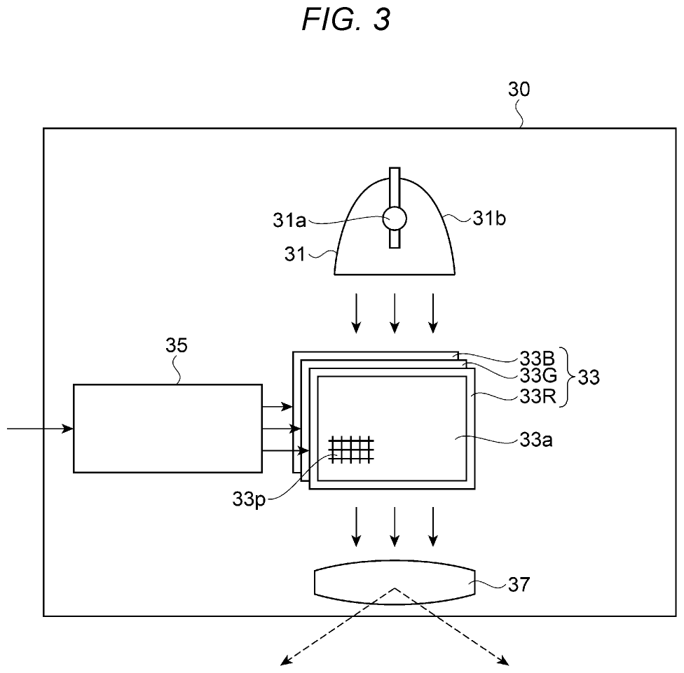

FIG. 3 shows a schematic configuration of the projecting unit 30. FIG. 3 shows an example of the projecting unit 30. The projecting unit 30 includes a light source 31, three liquid crystal light valves 33, a light valve driver 35, and a projection lens 37.

The light source 31 emits light to the liquid crystal light valve 33. The light source 31 includes a light source unit 31a, a reflector 31b, a not-illustrated integrator optical system, and a not-illustrated color separation optical system. The light source unit 31a emits light. The light source unit 31a is configured by a xenon lamp, an ultrahigh pressure mercury lamp, an LED (Light Emitting Diode), a laser light source, or the like. The light source unit 31a emits light based on the control of the projector control unit 23. The reflector 31b reduces fluctuation of an emitting direction of the light emitted by the light source unit 31a. The integrator optical system reduces luminance distribution fluctuation of the light emitted from the light source unit 31a. The light having passed through the reflector 31b is made incident on the color separation optical system. The color separation optical system separates the incident light into color light components of red, green, and blue.

The liquid crystal light valve 33 modulates the light emitted from the light source 31. The liquid crystal light valve 33 modulates the light to thereby generate the projection image 200. The liquid crystal light valve 33 is configured by, for example, a liquid crystal panel in which liquid crystal is encapsulated between a pair of transparent boards. The liquid crystal light valve 33 includes a rectangular pixel region 33a including a plurality of pixels 33p arrayed in a matrix. In the liquid crystal light valve 33, a driving voltage is applied to the liquid crystal for each of the pixels 33p. The projecting unit 30 shown in FIG. 3 includes the three liquid crystal light valves 33. The projecting unit 30 includes the liquid crystal light valves 33 but is not limited to this. The projecting unit 30 may include one or more DMDs (Digital Mirror Devices).

The three liquid crystal light valves 33 are a liquid crystal light valve for red light 33R, a liquid crystal light valve for green light 33G, and a liquid crystal light valve for blue light 33B. A red light component separated by the color separation optical system is made incident on the liquid crystal light valve for red light 33R. A green light component separated by the color separation optical system is made incident on the liquid crystal light valve for green light 33G. A blue light component separated by the color separation optical system is made incident on the liquid crystal light valve for blue light 33B.

The light valve driver 35 applies a driving voltage to the pixels 33p based on the image data received from the projector control unit 23. The light valve driver 35 is, for example, a control circuit. The driving voltage is supplied by a not-illustrated driving source. The light valve driver 35 may apply the driving voltage to the pixels 33p based on the image data corrected by the data corrector 25. When the light valve driver 35 applies the driving voltage to the pixels 33p, the pixels 33p are set to light transmittance based on the image data. The light emitted from the light source 31 is modulated by being transmitted through the pixel region 33a. The three liquid crystal light valves 33 form color component images for each of the color lights.

The projection lens 37 combines the color component images formed by the liquid crystal light valves 33 and enlarges and projects the color component images. The projection lens 37 projects the projection image 200 onto the projection surface SC. The projection image 200 is a plural-color image obtained by combining the color component images.

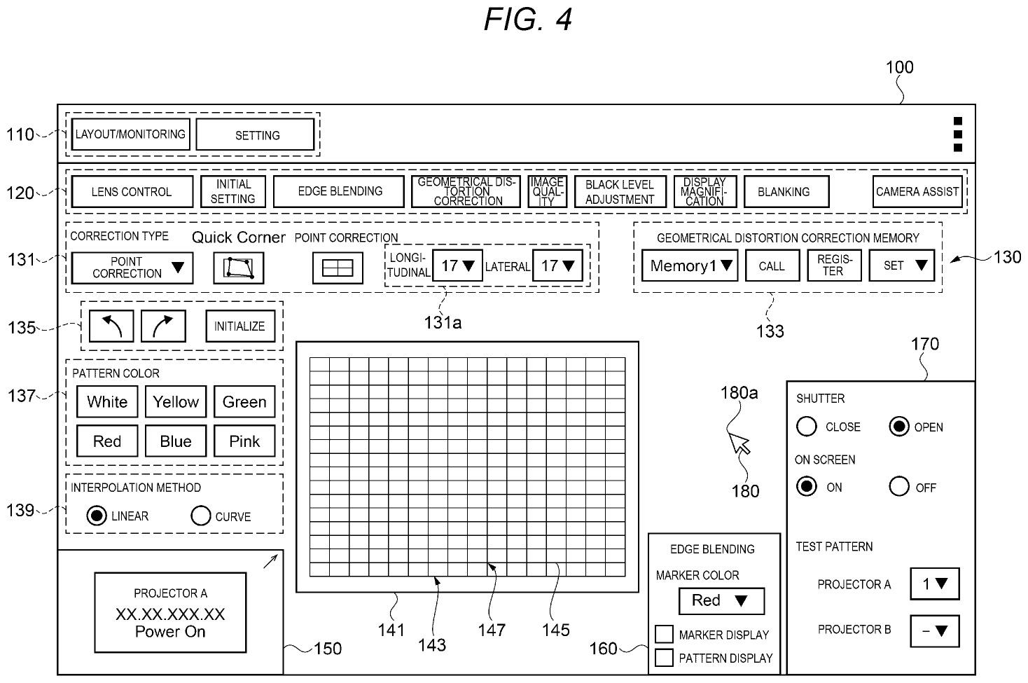

FIG. 4 shows a configuration of the management screen 100. The management screen 100 is displayed on the display 55 when the display control device 40 executes the image adjustment program AP. The management screen 100 is a screen displayed when various kinds of correction such as geometrical distortion correction and edge blending are performed. The user can adjust, using the management screen 100, the shape of the pattern image 210 projected onto the projection surface SC. The management screen 100 shown in FIG. 4 is a screen used when the user performs the geometrical distortion correction. When the user performs the edge blending or corner projection correction, the same screen as the management screen 100 shown in FIG. 4 is displayed.

The management screen 100 includes a basic setting region 110, a tab region 120, a geometrical distortion correction region 130, a sub-window display region 150, an edge blending region 160, and a projector setting region 170. The sub-window display region 150, the edge blending region 160, and the projector setting region 170 are displayed to be superimposed on the geometrical distortion correction region 130.

The basic setting region 110 displays a layout/monitoring tab and a setting tab. When the layout/monitoring tab is selected by input operation of the user, a layout/monitoring region is displayed in the management screen 100. When the setting tab is selected by input operation of the user, a setting region is displayed in the management screen 100.

The layout/monitoring region displays a state of the projector 20 connected to the display control device 40. The layout/monitoring region is not illustrated. The display control device 40 is connectable to a plurality of projectors 20. When the display control device 40 is connected to the projector 20, the layout/monitoring region displays a state of the projector 20. The state of the projector 20 is, a power ON/OFF state, a connection state including a network address, an error occurrence state, and the like. When the plurality of projectors 20 are connected to the display control device 40, the layout/monitoring region displays a layout of the plurality of projectors 20.

The setting region is a region for performing various kinds of setting. When the user selects, with input operation, one tab among a plurality of tabs displayed in the tab region 120, a region corresponding to the selected tab is displayed in the management screen 100. The management screen 100 shown in FIG. 4 shows, as a setting region, the geometrical distortion correction region 130 for setting geometrical distortion correction.

The tab region 120 displays a lens control tab, an initial setting tab, an edge blending tab, a geometrical distortion correction tab, an image quality tab, a black level adjustment tab, a display magnification tab, a blanking tab, and a camera assist tab.

When the lens control tab is selected by the input operation of the user, a lens control setting region is displayed in the management screen 100. The lens control setting region is not illustrated. The lens control setting region displays various icons and the like for controlling lenses of the projector 20. The user performs input operation to the various icons and the like displayed in the lens control setting region to thereby adjust, for example, focus of the lenses.

When the initial setting tab is selected by the input operation of the user, an initial setting region is displayed in the management screen 100. The initial setting region is not illustrated. The initial setting region displays various icons and the like relating to setting of the projector 20. The user performs input operation to the various icons and the like displayed in the initial setting region to thereby perform various kinds of initial setting. The initial setting is calibration of the light source 31, setting of a brightness level, initialization of the memory 21, and the like.

The edge blending tab is selected by the input operation of the user, an edge blending setting region is displayed in the management screen 100. The edge blending setting region is not illustrated. The edge blending setting region is used when one continuous projection image 200 is created by the plurality of projectors 20 based on the control of the display control device 40. The edge blending setting region displays various icons and the like for adjusting the shape of the projection image 200. The edge blending setting region displays the preview image 143 explained below. The user performs input operation to the various icons, the preview image 143, and the like displayed in the edge blending setting region to thereby adjust, for example, an overlapping region TA where the plurality of projection images 200 forming the one continuous projection image 200 overlap.

When the image quality tab is selected by the input operation of the user, an image quality setting region is displayed in the management screen 100. The image quality setting region is not illustrated. The image quality setting region displays various icons relating to image quality setting for the projection image 200. The user performs input operation to the various icons and the like displayed in the image quality setting region to thereby perform the image quality setting. Image quality to be set is color matching, brightness, contrast, frame interpolation, and the like.

When the black level adjustment tab is selected by the input operation of the user, a black level adjustment region is displayed in the management screen 100. The black level adjustment region is not illustrated. The black level adjustment region displays various icons relating to black level adjustment for the projection image 200 projected onto the projection surface SC by the plurality of projectors 20. The user performs input operation to the various icons and the like displayed in the black level adjustment region to thereby perform black level adjustment. The black level adjustment is adjustment of brightness, a tint, and the like of a portion where a video does not overlap.

When the display magnification tab is selected by the input operation of the user, a display magnification setting region is displayed in the management screen 100. The display magnification setting region is not illustrated. The display magnification setting region displays various icons relating to display magnification of the projection image 200. The user performs input operation to the various icons and the like displayed in the display magnification setting region to thereby perform display magnification setting. The display magnification setting is magnification setting for enlarging a part of the projection image 200.

When the blanking tab is selected by the input operation of the user, a blanking setting region is displayed in the management screen 100. The blanking setting region is not illustrated. The blanking setting region displays various icons relating to setting of the projection image 200. The user performs input operation to the various icons and the like displayed in the blanking setting region to thereby perform blanking setting. The blanking setting is setting for hiding a specific region of the projection image 200.

When the camera assist tab is selected by the input operation of the user, a camera assist adjustment region is displayed in the management screen 100. The camera assist adjustment region is not illustrated. The camera assist adjustment region displays various icons for executing automatic adjustment of the projection image 200 using a camera or the like incorporated in the projector 20. The user performs input operation to the various icons and the like displayed in the camera assist adjustment region to thereby cause the projector 20 to execute various kinds of automatic adjustment for the projection image 200. The automatic adjustment for the projection image 200 is screen matching, color calibration, tiling, and the like.

When the geometrical distortion correction tab is selected by the input operation of the user, the geometrical distortion correction region 130 shown in FIG. 4 is displayed in the management screen 100. The geometrical distortion correction region 130 displays various icons and the like relating to geometrical distortion correction. The geometrical distortion correction region 130 displays a correction setting section 131, a file setting section 133, an operation instructing section 135, a color setting section 137, a method setting section 139, and a display window 141. The display window 141 displays the preview window 143 including a plurality of grid lines 145 and a plurality of lattice points 147.

The correction setting section 131 displays various icons relating to setting of a correction type, a correction type display field for displaying a selected correction type, a preview image setting field 131a, and the like. Correction types to be selected are curved surface projection correction, corner projection correction, point correction, curve correction, and the like. In the curved surface projection correction, distortion that occurs when the projection image 200 is projected onto a curved surface such as a spherical surface is corrected. In the corner projection correction, distortion that occurs when the projection image 200 is projected onto an object having corners is corrected. In the point correction, as explained above, at least one of the plurality of lattice points 147 or at least one of a plurality of control points 215 is selected or moved, whereby geometrical distortion of the projection image 200 is corrected. In the curve correction, distortion that occurs when the projection image 200 is projected onto an object having a curved surface such as a blackboard is corrected. The preview image setting field 131a shown in FIG. 4 receives the number of longitudinal lattice points 147 and the number of lateral lattice points 147. In the following explanation, the point correction is mainly executed.

The file setting section 133 displays various icons and the like for receiving an instruction relating to a setting file. The setting file includes distortion correction setting performed in the geometrical distortion correction region 130. The user performs input operation to the various icons and the like displayed in the file setting section 133 to thereby instruct storage of the setting file in the storage unit 41.

The operation instructing section 135 displays various icons for causing the user to execute control for the input operation performed in the geometrical distortion correction region 130. The user performs the input operation to the various icons displayed in the operation instructing section 135 to thereby, for example, cancel input operation input immediately before the input operation.

The color setting section 137 displays a plurality of icons concerning designation of a color of the grid lines 145 or the lattice points 147 displayed on the display window 141. When the user performs the input operation to one icon among the plurality of icons displayed in the color setting section 137, the color of the grid lines 145 or the lattice points 147 displayed on the display window 141 is changed.

The method setting section 139 displays a selection button for selecting a method of interpolation among the lattice points 147. The method setting section 139 shown in FIG. 4 is capable of selecting linear interpolation or curve interpolation. The interpolation method is a method of position correction among the lattice points 147 adjacent to one another.

The display window 141 displays the preview image 143. The preview image 143 corresponds to the pattern image 210 projected onto the projection surface SC by the projector 20. The preview image 143 is configured by the grid lines 145 and the lattice points 147. The preview image 143 is displayed based on screen data. The screen data is generated by the display controller 49 using default screen data stored in the storage unit 41. The default screen data includes a predetermined number of the grid lines 145 and a predetermined interval among the grid lines 145 or a predetermined number of the lattice points 147 and a predetermined interval among the lattice points 147. The number of the lattice points 147 included in the default screen data is corrected by a value input to the preview image setting field 131a. The screen data includes the number of the lattice points 147 corrected based on a value input to the preview image setting field 131a. The display window 141 displays the entire preview image 143.

The screen data generated by the display controller 49 is transmitted to the display 55. The display 55 receives the screen data. The display 55 displays the preview image 143 on the display window 141 based on the received screen data. The display control device 40 causes, based on the screen data, the display 55 to display the preview image 143.

The preview image 143 is configured by the plurality of grid lines 145 and the plurality of lattice points 147. The plurality of grid lines 145 include the grid lines 145 extending along the vertical axis of the display window 141 and the grid lines 145 extending along the horizontal axis of the display window 141. The plurality of grid lines 145 extending along the vertical axis are arranged at a predetermined interval along the horizontal axis of the display window 141. The plurality of grid lines 145 extending along the horizontal axis are arranged at a predetermined interval along the vertical axis of the display window 141. Intersections of the grid lines 145 extending along the vertical axis of the display window 141 and the grid lines 145 extending along the horizontal axis of the display window 141 are the lattice points 147. The lattice points 147 are arranged at a predetermined interval along the vertical axis of the display window 141. The number of the lattice points 147 arranged along the vertical axis of the display window 141 is the same as the longitudinal value set in the preview image setting field 131a. The lattice points 147 are arranged at a predetermined interval along the horizontal axis of the display window 141. The number of the lattice points 147 arranged along the horizontal axis of the display window 141 is the same as the lateral value set in the preview image setting field 131a.

The sub-window display region 150 displays a region or the like different from the geometrical distortion correction region 130. As an example, the sub-window display region 150 may display the layout/monitoring region or a part of the layout/monitoring region. When the user performs the input operation to the sub-window display region 150, a region displayed in the sub-window display region 150 is displayed on the management screen 100 while being switched from the geometrical distortion correction region 130.

The edge blending region 160 displays, for example, a selection button for receiving input operation relating to the edge blending. The edge blending region 160 is used when geometrical distortion correction is performed on the projection image 200 projected onto the projection surface SC using the plurality of projectors 20.

The projector setting region 170 displays, for example, a selection button for receiving input operation relating to setting of the projector 20. The projector setting region 170 is used when the display control device 40 is connected to one or more projectors 20. As an example, when selecting the pattern image 210 projected by one projector 20 among the plurality of projectors 20, the user performs operation for selecting any one of the plurality of projectors 20 in the projector setting region 170.

The management screen 100 displays a cursor 180. The cursor 180 moves according to cursor moving operation of the user. The cursor moving operation is an example of input operation. When the user performs the cursor moving operation using the input unit 53, the cursor 180 moves on the management screen 100. The cursor 180 is capable of moving on any grid lines 145 or lattice points 147. The user uses the cursor 180 when performing moving operation for any grid lines 145 or lattice points 147 or selection operation for the lattice points 147 and the like. The cursor 180 moves when the user performs the cursor moving operation using the input unit 53.

The cursor 180 shown in FIG. 4 has an arrow shape. The shape of the cursor 180 is not limited to the arrow shape. As the shape of the cursor 180, a cross shape, a circular shape, and the like can be selected as appropriate. A cursor tip 180a of the cursor 180 having the arrow shape indicates a pointed position by the user. The pointed position is changed as appropriate according to the shape of the cursor 180. When the shape of the cursor 180 is the cross shape as an example, the center position of the cursor 180 is the pointed position by the user.

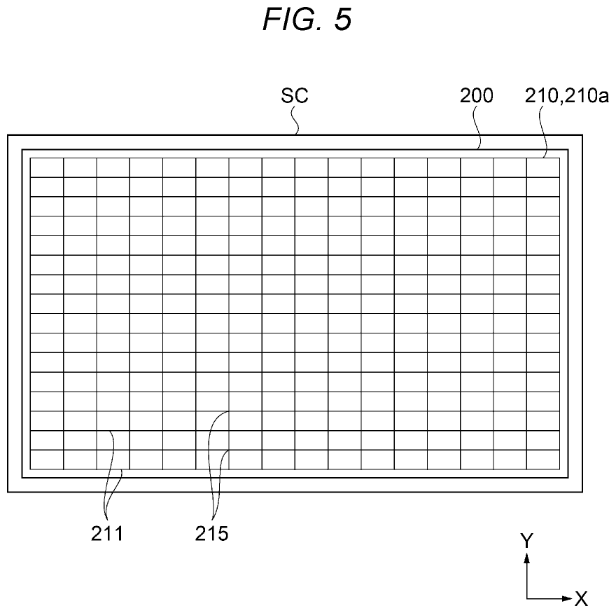

FIG. 5 shows an example of the pattern image 210. FIG. 5 shows a first pattern image 210a, which is an example of the pattern image 210. The first pattern image 210a is projected onto the projection surface SC by the projecting unit 30. The projecting unit 30 projects the projection image 200 including the first pattern image 210a onto the projection surface SC. The first pattern image 210a corresponds to the preview image 143 displayed on the management screen 100 shown in FIG. 4. The first pattern image 210a is projected onto the projection surface SC when the control unit 45 executes the image adjustment program AP. The first pattern image 210a may be projected onto the projection surface SC when the management screen 100 displays the geometrical distortion correction region 130 according to the input operation by the user.

The first pattern image 210a includes a plurality of control lines 211 and a plurality of control points 215. The plurality of control lines 211 include the control lines 211 extending along the X axis and the control lines 211 extending along the Y axis. The plurality of control lines 211 extending along the X axis are arranged at a predetermined interval along the Y axis. The plurality of control lines 211 extending along the Y axis are arranged at a predetermined interval along the X axis. The control points 215 are intersections of the control lines 211 extending along the X axis and the control lines 211 extending along the Y axis. The plurality of control points 215 are arrayed along the X axis and the Y axis. The user controls the control lines 211 or the control points 215 in the pattern image 210 and adjusts the shape of the projection image 200. The pattern image 210 including the first pattern image 210a corresponds to an example of the adjustment image. The pattern image 210 corresponds to an example of the projection image 200. The control point 215 corresponds to an example of the adjustment point.

The first pattern image 210a corresponds to the preview image 143 at the time when longitudinal seventeen and lateral seventeen lattice points 147 are set in the preview image setting of the management screen 100 shown in FIG. 4. The number of the control points 215 in the first pattern image 210a coincides with the number of the lattice points 147 in the preview image 143. The lateral of the preview image setting and the X axis of the projection surface SC correspond to each other. The longitudinal of the preview image setting and the Y axis of the projection surface SC correspond to each other. Each of the control lines 211 in the first pattern image 210a corresponds to each of the grid lines 145 in the preview image 143. Each of the control points 215 in the first pattern image 210a corresponds to each of the lattice points 147 in the preview image 143.

The first pattern image 210a, which is an example of the pattern image 210, includes the plurality of control lines 211 and the plurality of control points 215 but is not limited to this configuration. As an example, the pattern image 210 may be an image including the plurality of control points 215 and not including the plurality of control lines 211. The pattern image 210 only has to be configured such that any position can be designated when the shape of the pattern image 210 is adjusted.

When the projection surface SC is a smooth surface, as shown in FIG. 5, the plurality of control lines 211 and the plurality of control points 215 are equally arranged along the X axis and the Y axis. When unevenness is present on the projection surface SC, as an example, the control lines 211 and the control points 215 projected on the position of the unevenness are projected onto unequal positions different from equally arranged positions. The user confirms, as adjustment targets, the control lines 211 or the control points 215 projected onto the unequal positions.

When the control unit 45 causes the projector 20 to project the projection image 200 including the pattern image 210 onto the projection surface SC, the mode setter 47 preferably sets the voice instruction mode as the input mode. The display control device 40 becomes capable of executing the voice instruction mode. When the projection image 200 including the first pattern image 210a is projected onto the projection surface SC, the user can immediately perform an instruction by voice.

The display control device 40 preferably causes the projector 20 to project, as the projection image 200, the first pattern image 210a for adjusting the shape of the projection image 200, the first pattern image 210a including the plurality of control points 215, and is capable of executing the voice instruction mode in a period in which the first pattern image 210a is projected onto the projection surface SC. In other words, the display control device 40 preferably causes the projector 20 to project, as the projection image 200, the pattern image 210 for adjusting the shape of the projection image 200, the pattern image 210 including the plurality of control points 215, and is capable of executing the voice instruction mode in a period in which the pattern image 210 is projected onto the projection surface SC.

The user can perform the instruction by voice while checking the first pattern image 210a including the plurality of control points 215.

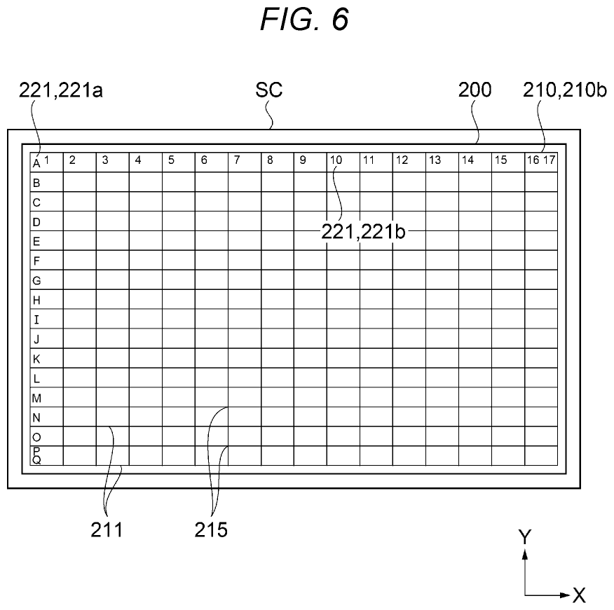

FIG. 6 shows an example of the pattern image 210. FIG. 6 shows a second pattern image 210b, which is an example of the pattern image 210. The second pattern image 210b is projected onto the projection surface SC by the projecting unit 30. The projecting unit 30 projects the projection image 200 including the second pattern image 210b onto the projection surface SC. The second pattern image 210b corresponds to the preview image 143 displayed on the management screen 100 shown in FIG. 4. The second pattern image 210b is projected onto the projection surface SC when the control unit 45 executes the image adjustment program AP. The second pattern image 210b may be projected onto the projection surface SC when the management screen 100 displays the geometrical distortion correction region 130 according to the input operation by the user.

The second pattern image 210b includes the plurality of control lines 211, the plurality of control points 215, and a plurality of guide images 221. The control lines 211 and the control points 215 included in the second pattern image 210b are the same as the control lines 211 and the control points 215 included in the first pattern image 210a.

The guide images 221 indicate the positions of the control lines 211 and the control points 215. The guide images 221 are shown in the second pattern image 210b. The plurality of guide images 221 shown in FIG. 6 are arranged to respectively correspond to the plurality of control lines 211. The plurality of guide images 221 shown in FIG. 6 include a plurality of first guide images 221a and a plurality of second guide images 221b. The guide images 221 correspond to an example of the position information image.

The first guide images 221a indicate the positions of the control lines 211 extending along the X axis. The plurality of first guide images 221a respectively correspond to the positions of the control lines 211 extending along the X axis. The first guide images 221a are displayed in alphabets. Among the plurality of first guide images 221a, “E” indicates a fourth control line 211 in a-Y direction from the control line 211 at the top end in a +Y direction. The first guide images 221a are indicated by the alphabets but are not limited to this. The first guide images 221a only have to be labels capable of distinguishing the plurality of control lines 211 extending along the X axis. The plurality of first guide images 221a are displayed in end positions in a-X direction of the second pattern images 210b but are not limited to this. The plurality of first guide images 221a are arranged as appropriate.

The second guide images 221b indicate the positions of the control lines 211 extending along the Y axis. The plurality of second guide images 221b respectively correspond to the positions of the control lines 211 extending along the Y axis. The second guide images 221b are displayed in numerical values. Among the plurality of second guide images 221b, “5” indicates a fourth control line 211 in a +X direction from the control line 211 at the leftmost end in the −X direction. The second guide images 221b are indicated by the numerical values but are not limited to this. The second guide images 221b only have to be labels capable of distinguishing the plurality of control lines 221 extending along the Y axis. The second guide images 221b are preferably labels distinguishable from the first guide images 221a by voice. The plurality of second guide images 221b are displayed at the end positions in the +Y direction of the second pattern images 210b but are not limited to this. The plurality of second guide images 221b are arranged as appropriate.

The control points 215 are indicated by combining the first guide images 221a and the second guide images 221b. “A1” indicates the position at the leftmost end in the −X direction and at the top end in the +Y direction among the positions of the plurality of control points 215. “E5” indicates a position fourth in the +X direction and fourth in the −Y direction based on the control point 215 in the “A1” position.

The user can select the control line 211 extending along the Y axis using the first guide image 221a. The user can select the control line 211 extending along the X axis using the second guide image 221b. The user can select the control point 215 using the first guide image 221a and the second guide image 221b.

When the voice instruction mode can be executed, the user utters guide voice and selection instruction voice corresponding to the guide image 221. The guide voice is voice for causing the executor 48 to designate the control line 211 or the control point 215. The control line 211 or the control point 215 selected by the guide voice corresponds to an example of the selection target. The selection instruction voice is voice for transmitting a selection instruction to the executor 48. The voice input unit 43 acquires voice including the guide voice and the selection instruction voice. The voice input unit 43 transmits the voice including the guide voice and the selection instruction voice to the voice processor 46. The voice processor 46 receives the voice. The voice processor 46 extracts the selection instruction included in the voice. The selection instruction corresponds to an example of the selection command. The voice processor 46 generates a selection instruction command including a selection instruction for selecting the control line 211 or the control point 215. The voice processor 46 transmits the selection instruction command to the executor 48 and the display controller 49.

The user may select the plurality of control lines 211 or the plurality of control points 215. The user utters guide voice corresponding to the plurality of control lines 211 or the plurality of control points 215. As an example, when selecting the control points 215 in an “E5” position to a “G7” position, the user utters voice including “select points in E5 to G7”. “E5 to G7” is an example of the guide voice. The voice input unit 43 acquires voice including the guide voice and the selection instruction voice and transmits the voice to the voice processor 46. The voice processor 46 extracts the selection instruction included in the voice. The voice processor 46 generates, based on the voice, a selection instruction command for selecting the control points 215 in the “E5” position, the “E6” position, the “E7” position, the “F5 position”, the “F6” position, the “F7” position, the “G5” position, the “G6” position, and the “G7” position. The guide voice is voice for selecting at least one or more control lines 211 or one or more control points 215.

When executing the voice instruction mode, the display control device 40 causes the display 55 to display the plurality of guide images 221 indicating the positions of the plurality of control points 215 on the pattern image 210. The instruction includes a selection instruction for selecting at least one of the plurality of control points 215 based on at least one of the plurality of guide images 221.

By referring to the guide image 221, the user can distinguish the control point 215 that the user desires to select.

The guide images 221 shown in FIG. 6 indicate the positions of the control lines 211 and the control points 215 but are not limited to this. The guide images 221 may be identification signs indicating the plurality of control lines 211. The guide images 221 may be identification signs indicating the plurality of control points 215. As an example, the guide images 221 may be identification signs for respectively identifying the plurality of control points 215. At this time, the guide images 221 are respectively displayed near the control points 215 using numbers 1 to n as identification signals with respect to n control points 215.

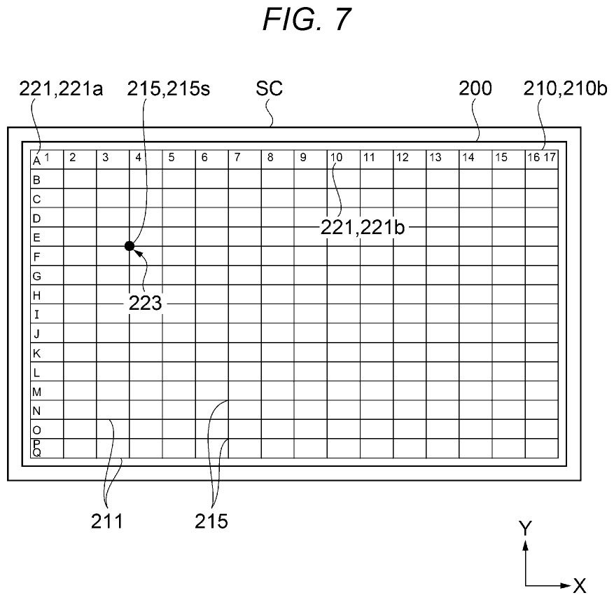

FIG. 7 shows an example of the pattern image 210. FIG. 7 shows the second pattern image 210b, which is an example of the pattern image 210. The second pattern image 210b is projected onto the projection surface SC by the projecting unit 30. The projecting unit 30 projects the projection image 200 including the second pattern image 210b onto the projection surface SC. FIG. 7 shows the second pattern image 210b at the time when the user selects a desired control point 215 as a selected control point 215s. In the second pattern image 210b shown in FIG. 7, a control point image 223 is displayed on the selected control point 215s.

The selected control point 215s is the control point 215 selected by the user. The selected control point 215s is selected by voice instruction input of the user. As an example, the user utters voice including “select the point of F4”. “F4” is an example of guide voice. “Select the point” is an example of selection instruction voice. The voice input unit 43 acquires voice including the guide voice and the selection instruction voice. The voice input unit 43 transmits the voice to the voice processor 46. The voice processor 46 receives the voice. The voice processor 46 extracts a selection instruction included in the voice. The voice processor 46 generates, based on the voice, a selection instruction command for selecting the control point 215 in the “F4” position. The voice processor 46 transmits the selection instruction command to the executer 48 and the display controller 49. The selected control point 215s corresponds to an example of the selection target.

The control point image 223 is an image indicating the selected control point 215s. When the user selects the control point 215 in a desired position, the control point image 223 is displayed on the selected control point 215s. The control point image 223 indicates the position of the selected control point 215s in the second pattern image 210b. When receiving the selectin instruction command for selecting the control point 215 in the “F4” position, the executor 48 causes the projector 20 to project the projection image 200 including the control point image 223. The control point image 223 shown in FIG. 7 is formed in a circular shape but is not limited to this. A form of the control point image 223 is set as appropriate if the position of the selected control point 215s can be identified by the form. The control point image 223 corresponds to an example of the selected display image.

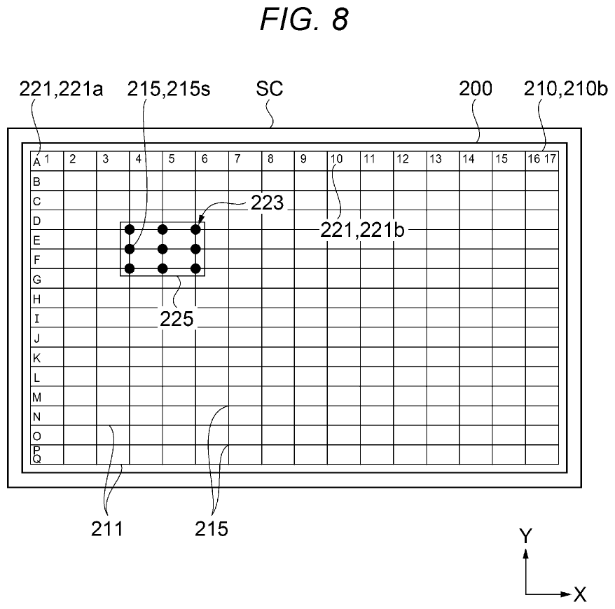

FIG. 8 shows an example of the pattern image 210. FIG. 8 shows the second pattern image 210b, which is an example of the pattern image 210. The second pattern image 210b is projected onto the projection surface SC by the projecting unit 30. The projecting unit 30 projects the projection image 200 including the second pattern image 210b onto the projection surface SC. FIG. 8 shows the second pattern image 210b at the time when the user selects the plurality of control points 215 as the selected control points 215s. In the second pattern image 210b shown in FIG. 8, a plurality of control point images 223 are respectively displayed in the positions of a plurality of selected control points 215s. A region display image 225 is displayed on the second pattern image 210b shown in FIG. 8.

The plurality of selected control points 215s are the control points 215 selected by the user. The plurality of selected control points 215s are selected by voice instruction input of the user. As an example, the user utters voice including “select the points of E4 to G6”. “E4 to G6” is an example of guide voice. “Selects the points” is an example of selection instruction voice. The voice input unit 43 acquires voice including the guide voice and the selection instruction voice. The voice input unit 43 transmits the voice to the voice processor 46. The voice processor 46 receives the voice. The voice processor 46 extracts a selection instruction included in the voice. The voice processor 46 generates, based on the voice, a selection instruction command for selecting the control points 215 in the “E4” position, the “E5” position, the “E6” position, the “F4” position, the “F5” position, the “F6” position, the “G4” position, the “G5” position, and the “G6” position. The voice processor 46 transmits the selection instruction command to the executor 48 and the display controller 49.

The plurality of control point images 223 are images respectively indicating the plurality of selected control points 215s. When the user selects the plurality of control points 215 corresponding to desired positions, the plurality of control point images 223 are respectively displayed in the positions of the selected control points 215s. The plurality of control point images 223 indicate the positions of the plurality of selected control points 215s in the second pattern image 210b. When receiving a selection instruction command for selecting the plurality of control points 215, the executor 48 causes the projector 20 to project the projection image 200 including the plurality of control point images 223. Each of the plurality of control point images 223 shown in FIG. 8 is formed in a circular shape but is not limited to this. A form of the control point image 223 is set as appropriate if the position of the selected control point 215s can be identified by the form.

The region display image 225 is an image indicating a region where the plurality of selected control points 215s are located. When the user selects the plurality of control points 215 corresponding to the desired positions, the region display image 225 is displayed in a position surrounding the plurality of selected control points 215s. The region display image 225 indicates the positions of the plurality of selected control points 215s in the second pattern image 210b. When receiving a selection instruction command for selecting the plurality of selected control points 215s, the executor 48 causes the projector 20 to project the projection image 200 including the region display image 225. The region display image 225 shown in FIG. 8 is formed in a rectangular shape but is not limited to this. A form of the region display image 225 is set as appropriate if the positions of the selected control points 215s can be identified by the form. The region display image 225 corresponds to an example of the selected display image.

FIG. 8 shows the control point images 223 and the region display image 225 but is not limited to this. When the plurality of selected control points 215s are selected, the control point images 223 or the region display image 225 may be displayed. The control point images 223 and the region display image 225 are displayed when at least one control point 215 is selected as the selected control point 215s.

When at least one of the plurality of control points 215 is selected as the selected control point 215s according to a selection instruction, the display control device 40 causes the projector 20 to project the control point image 223 or the region display image 225 indicating the selected control point 215s.

The user can check the position of the selected control point 215s.

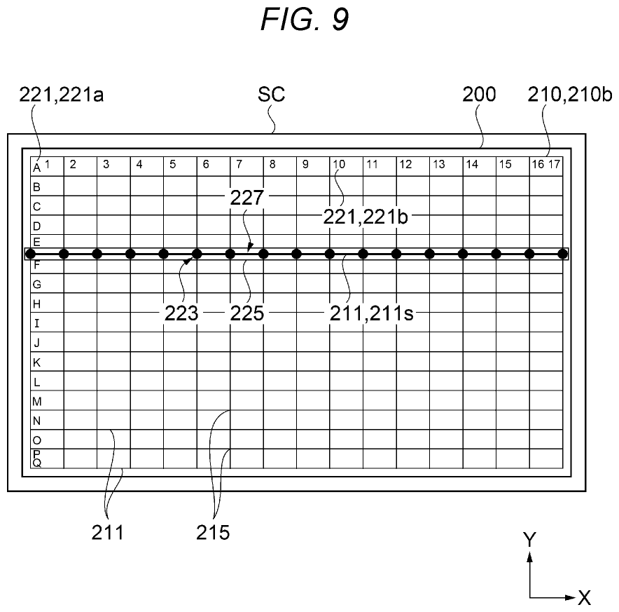

FIG. 9 shows an example of the pattern image 210. FIG. 9 shows the second pattern image 210b, which is an example of the pattern image 210. The second pattern image 210b is projected onto the projection surface SC by the projecting unit 30. The projecting unit 30 projects the projection image 200 including the second pattern image 210b onto the projection surface SC. FIG. 9 shows the second pattern image 210b at the time when the user selects a desired control line 211 as a selected control line 211s. On the second pattern image 210b shown in FIG. 9, the control point images 223, the region display image 225, and a control line image 227 are displayed.

The selected control line 211s is the control line 211 selected by the user. The selected control line 211s is selected by voice instruction input of the user. As an example, the user utters voice including “select the line of F”. “F” is an example of guide voice. “Select the line” is an example of selection instruction voice. The voice input unit 43 acquires voice including the guide voice and the selection instruction voice. The voice input unit 43 transmits the voice to the voice processor 46. The voice processor 46 receives the voice. The voice processor 46 extracts a selection instruction included in the voice. The voice processor 46 generates, based on the voice, a selection instruction command for selecting the control line 211 in the “F” position”. The voice processor 46 transmits the selection instruction command to the executor 48 and the display controller 49. The selected control line 211s corresponds to an example of the selection target.

The control point images 223 are images indicating the selected control line 211s. The control point images 223 indicating the control points 215 located on the selected control line 211s are displayed, whereby the position of the selected control line 211s is indicated. When the user selects the control line 211 in a desired position, the control point images 223 are displayed at the control points 215 located on the selected control line 211s. The control point images 223 indicate the position of the selected control line 211s in the second pattern image 210b. When receiving the selection instruction command for selecting the control line 211 in the “F” position, the executor 48 causes the projector 20 to project a projection image 200 including the control point images 223. The control point images 223 shown in FIG. 9 are formed in a circular shape but are not limited to this.

The region display image 225 is an image indicating a region where the selected control line 211s is located. When the user selects the control line 211 corresponding to a desired position, the region display image 225 is displayed in a position surrounding the selected control line 211s. The region display image 225 indicates the position of the selected control line 211s in the second pattern image 210b. When receiving the selection instruction command for selecting the selected control line 211s, the executor 48 causes the projector 20 to project the projection image 200 including the region display image 225. The region display image 225 shown in FIG. 9 is formed in a rectangular shape but is not limited to this. A form of the region display image 225 is set as appropriate if the position of the selected control line 211s can be identified by the form.

The control line image 227 is an image indicating the selected control line 211s. The control line image 227 is displayed on the selected control line 211s. When the user selects the control line 211 in a desired position, the control line image 227 is displayed on the selected control line 211s. The control line image 227 indicates the position of the selected control line 211s in the second pattern image 210b. When receiving the selection instruction command for selecting the control line 211 in the “F” position, the executor 48 causes the projector 20 to project the projection image 200 including the control line image 227. The control line image 227 shown in FIG. 9 is formed by a thick line but is not limited to this. A form of the control line image 227 is set as appropriate if the position of the selected control line 211s can be identified by the form. The control line image 227 corresponds to an example of the selected display image.

FIG. 9 shows the control point images 223, the region display image 225, and the control line image 227 but is not limited to this. At least one of the control point images 223, the region display image 225, and the control line image 227 only has to be displayed on the pattern image 210. The user can check the position of the selected control line 211s by visually recognizing any one of the control point images 223, the region display image 225, and the control line image 227.

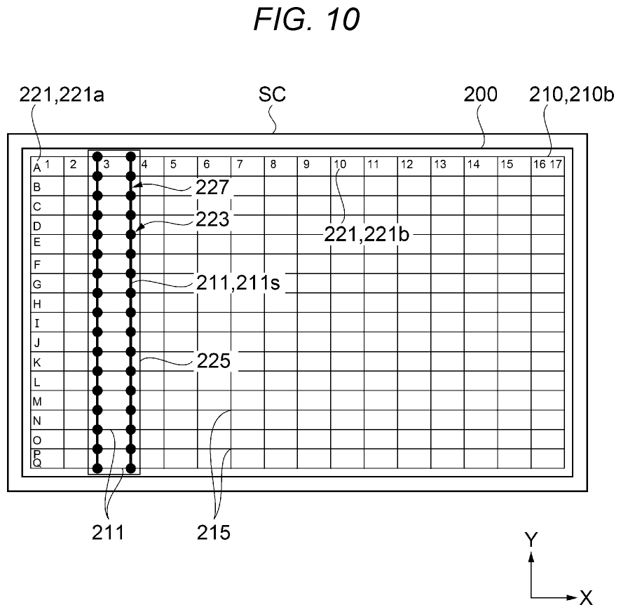

FIG. 10 shows an example of the pattern image 210. FIG. 10 shows the second pattern image 210b, which is an example of the pattern image 210. The second pattern image 210b is projected onto the projection surface SC by the projecting unit 30. The projecting unit 30 projects the projection image 200 including the second pattern image 210b onto the projection surface SC. FIG. 10 shows the second pattern image 210b at the time when the user selects a plurality of control lines 211 as selected control lines 211s. On the second pattern image 210b shown in FIG. 10, a plurality of control point images 223, the region display image 225, and a plurality of control line images 227 are displayed.

The plurality of control point images 223 are images indicating a plurality of selected control lines 211s. The control point images 223 indicating the control points 215 located on the selected control lines 211s are displayed, whereby the positions of the selected control lines 211s are indicated. When the user selects the plurality of control lines 211 corresponding to desired positions, the plurality of control point images 223 are displayed at the control points 215 located on the plurality of selected control lines 211s. The plurality of control point images 223 indicate the positions of the selected control lines 211s in the second pattern image 210b. When receiving a selection instruction command for selecting the control lines 211 in the “3” position and the “4” position, the executor 48 causes the projector 20 to project the projection image 200 including the control point images 223. The control point images 223 shown in FIG. 10 are formed in a circular shape but are not limited to this.

The region display image 225 is an image indicating a region where the plurality of selected control lines 211s are located. When the user selects the plurality of control lines 211 corresponding to the desired positions, the region display image 225 is displayed in a position surrounding the plurality of selected control lines 211s. The region display image 225 indicates the positions of the plurality of selected control lines 211s in the second pattern image 210b. When receiving a selection instruction command for selecting the selected control lines 211s, the executor 48 causes the projector 20 to project the projection image 200 including the region display image 225.

The plurality of control line images 227 are images indicating the plurality of selected control lines 211s. The plurality of control line images 227 are displayed in positions respectively indicating the plurality of selected control lines 211s. When the user selects the plurality of control lines 211 corresponding to the desired positions, the plurality of control line images 227 are displayed on the selected control lines 211s. The control line images 227 indicate the positions of the plurality of selected control lines 211s in the second pattern image 210b. When receiving the selection instruction command for selecting the control lines 211 in the “3” position and the “4” position, the executor 48 causes the projector 20 to project the projection image 200 including the plurality of control line images 227.

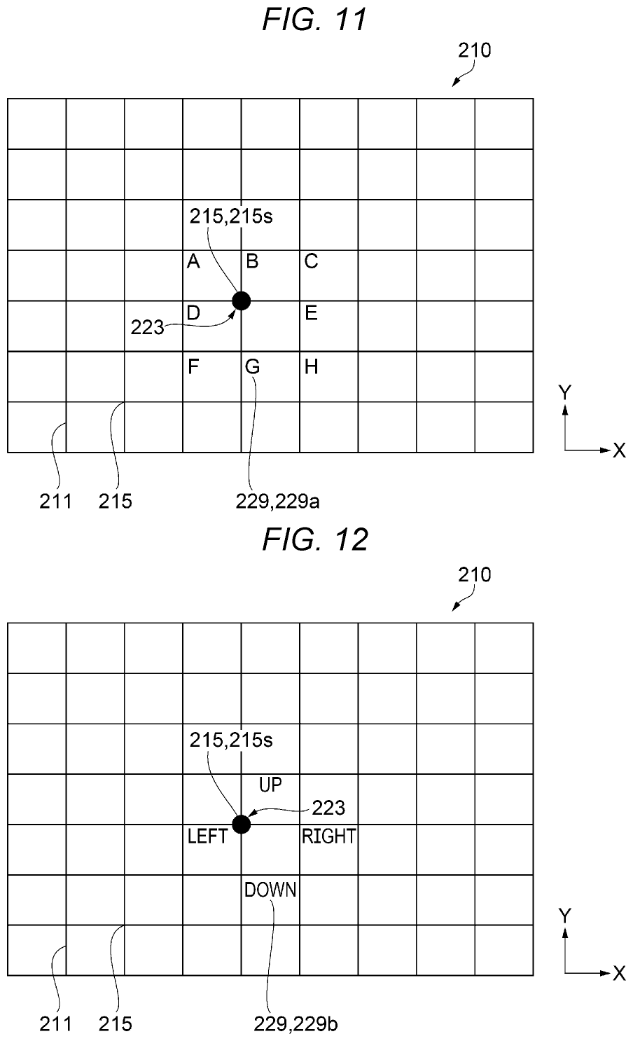

FIG. 11 enlarges and shows a part of the pattern image 210. FIG. 10 enlarges and shows a part of the first pattern image 210a, which is an example of the pattern image 210. The first pattern image 210a is projected onto the projection surface SC by the projecting unit 30. The projecting unit 30 projects the projection image 200 including the first pattern image 210a onto the projection surface SC. FIG. 11 shows the first pattern image 210a at the time when the user selects a desired control point 215 as the selected control point 215s. On the first pattern image 210a shown in FIG. 11, the control point image 223 and a plurality of first direction instruction images 229a are displayed. The first position instruction images 229a are an example of direction instruction images 229. The control point image 223 is the same as the control point image 223 shown in FIG. 7.

The first direction instruction images 229a indicate, with signs, directions in which the selected control point 215s can move. Each of the plurality of first direction instruction images 229a instructs a direction with respect to the selected control point 215s. The plurality of first direction instruction images 229a are represented by a sign A, a sign B, a sign C, a sign D, a sing E, a sign F, a sign G, and a sign H. As an example, the sign A indicates the −X direction and the +Y direction with respect to the selected control point 215s. The sign B indicates the +Y direction with respect to the selected control point 215s.

When uttering a movement instruction for moving the selected control point 215s, the user utters a sign corresponding to a desired direction in the plurality of direction instruction images 229. As an example, the user utters “move the point in the B direction”. “B” is an example of direction instruction voice for instructing a moving direction. “Move the point” is an example of movement instruction voice. The voice input unit 43 acquires voice including the direction instruction voice and the movement instruction voice. The voice input unit 43 transmits the voice to the voice processor 46. The voice processor 46 receives the voice. The voice processor 46 extracts a movement instruction included in the voice. The voice processor 46 generates, based on the voice, a movement instruction command for moving the selected control point 215s in the B direction. The voice processor 46 transmits the movement instruction command to the executor 48 and the display controller 49. A moving direction included in the direction instruction voice corresponds to an example of the movement instruction direction. The moving direction is an example of adjustment data. The movement instruction corresponds to the movement command.

FIG. 12 enlarges and shows a part of the pattern image 210. FIG. 12 enlarges and shows a part of the first pattern image 210a, which is an example of the pattern image 210. The first pattern image 210a is projected onto the projection surface SC by the projecting unit 30. The projecting unit 30 projects the projection image 200 including the first pattern image 210a onto the projection surface SC. FIG. 12 shows the first pattern image 210a at the time when the user selects the desired control point 215 as the selected control point 215s. On the first pattern image 210a shown in FIG. 12, the control point image 223 and a plurality of second direction instruction images 229b are displayed. The second direction instruction images 229b are an example of direction instruction images 229. The control point image 223 is the same as the control point image 223 shown in FIG. 7.

The second direction instruction images 229b indicate directions in which the selected control point 215s can move. Each of the plurality of second direction instruction images 229b indicates a direction with respect to the selected control point 215s. The plurality of second direction instruction images 229 are represented by UP, DOWN, LEFT, and RIGHT. As an example, UP indicates the +Y direction with respect to the selected control point 215s.

When uttering a movement instruction for moving the selected control point 215s, the user utters a desired direction and a movement instruction amount in the plurality of second direction instruction images 229b. As an example, the user utters “move the point by five points in the UP direction”. “UP” is an example of direction instruction voice for instructing a moving direction. “Five points” is an example of movement amount instruction voice for instructing a movement amount. The moving direction and the movement amount included in the voice correspond to an example of the instruction value. The movement amount is an example of adjustment data. “Move the point” is an example of movement instruction voice. The voice input unit 43 acquires voice including the direction instruction voice, the movement amount instruction voice, and the movement instruction voice. The voice input unit 43 transmits the voice to the voice processor 46. The voice processor 46 receives the voice. The voice processor 46 extracts a movement instruction included in the voice. The voice processor 46 generates, based on the voice, a movement instruction command for moving the selected control point 215s by five pixels in the B direction. The voice processor 46 transmits the movement instruction command to the executor 48 and the display controller 49.

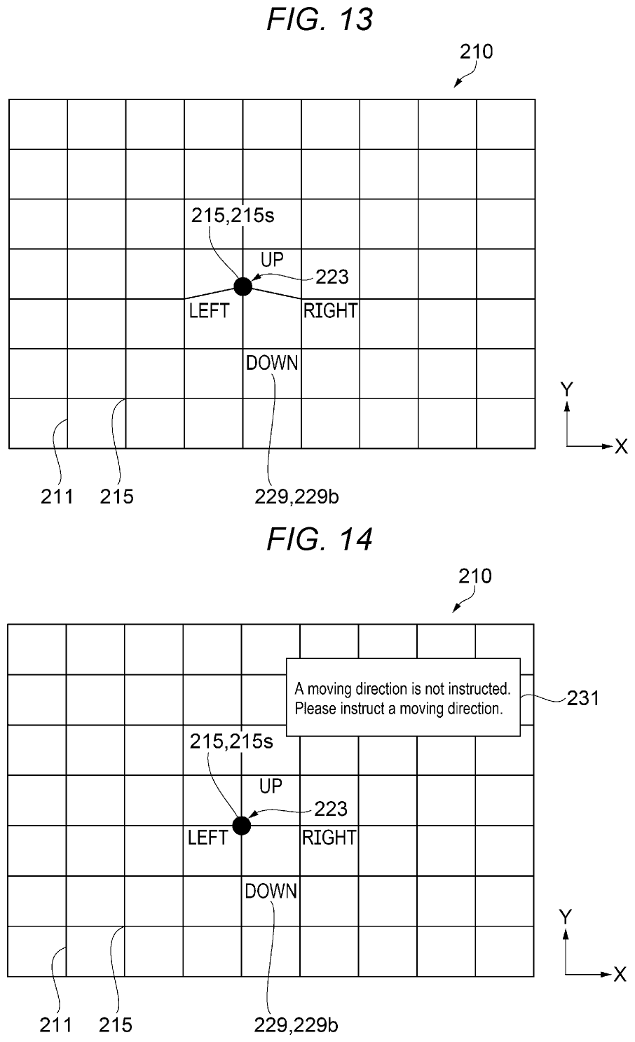

FIG. 13 enlarges and shows a part of the pattern image 210. FIG. 13 enlarges and shows a part of the first pattern image 210a, which is an example of the pattern image 210. FIG. 13 shows the first pattern image 210a at the time when the user performs voice instruction input to the first pattern image 210a shown in FIG. 12. FIG. 13 shows a processing result at the time when the user utters voice “move the point by n points in the UP direction”. Here, n is any integer.

The voice input unit 43 acquires the voice. The voice input unit 43 transmits the voice to the voice processor 46. The voice processor 46 receives the voice. The voice processor 46 extracts a movement instruction included in the voice. The voice processor 46 generates, based on the voice, a movement instruction command for moving the selected control point 215s by n pixels in the UP direction. The voice processor 46 transmits the movement instruction command to the executor 48 and the display controller 49. The executor 48 receives the movement instruction command. The executor 48 performs processing based on the movement instruction command and causes the projector 20 to project the first pattern image 210a shown in FIG. 13. The movement instruction corresponds to an example of the correction instruction.

The selected control point 215s shown in FIG. 13 moves according to the movement instruction voice. The selected control point 215s moves to a position in the +Y direction according to the direction instruction voice. The selected control point 215s moves by n pixels in the +Y direction according to the movement instruction voice. The user can check a direction in which the selected control point 215s has moved and a movement amount by checking the second direction instruction images 229b.

When moving the selected control point 215s to the position shown in FIG. 13, the user utters the movement amount instruction voice but is not limited to this. When the movement amount instruction voice is not uttered, the executor 48 may move the selected control point 215s by a predetermined distance. The user preferably utters the movement amount instruction voice. The executor 48 can move, based on the movement amount instruction voice, the selected control point 215s by a distance desired by the user.

The instruction includes a movement instruction for moving at least one of the plurality of control points 215.

The user becomes capable of moving the selected control point 215s with the voice instruction input.

In a state in which the projector 20 is projecting the first pattern image 210a shown in FIG. 13, the display control device 40 can acquire voice. As an example, when the user utters voice including “cancel the movement”, the executor 48 can return the selected control point 215s to a position before the movement. “Cancel the movement” is movement cancellation instruction voice. The voice input unit 43 acquires voice including the movement cancellation instruction voice. The voice input unit 43 transmits the voice to the voice processor 46. The voice processor 46 extracts a voice cancellation instruction included in the voice. The voice processor 46 generates, based on the voice, a movement cancellation instruction command for cancelling the movement of the selected control point 215s. The voice processor 46 transmits the movement cancellation instruction command to the executor 48 and the display controller 49. The executor 48 receives the movement cancellation instruction command. The executor 48 performs processing based on the movement cancellation instruction command and causes the projector 20 to project the first pattern image 210a shown in FIG. 12. The movement cancellation instruction corresponds to an example of the correction instruction.

When a correction instruction for correcting the projection image 200 is included in the voice acquired by the voice input unit 43, the display control device 40 causes the projector 20 to project the projection image 200 including an adjusted first pattern image 210a. When the correction instruction for correcting the projection image 200 is included in the voice acquired by the voice input unit 43, the display control device 40 causes the projector 20 to project the projection image 200 including the first pattern image 210a.

The user can cause the projector 20 to project the first pattern image 210a adjusted by the voice instruction input. By checking the adjusted first pattern image 210a, the user can determine whether an adjustment result is appropriate.

FIG. 14 enlarges and shows a part of the pattern image 210. FIG. 14 enlarges and shows a part of the first pattern image 210a, which is an example of the pattern image 210. FIG. 14 shows the first pattern image 210a at the time when the user performs voice instruction input to the first pattern image 210a shown in FIG. 12. FIG. 14 shows a processing result at the time when the user utters voice “move the point by n points”. Here, n is any integer.

FIG. 14 shows a message image 231. The message image 231 is an image including a message to be notified to the user. The message image 231 shown in FIG. 14 indicates that a moving direction is not instructed. The executor 48 generates a movement instruction command based on voice. When generating the movement instruction command, the executor 48 determines whether instruction content included in the voice is insufficient or defective. When determining that the instruction content is insufficient or defective, the executor 48 causes the projector 20 to project the message image 231. The user can check defectiveness of the instruction content by the voice instruction input by checking the message image 231.

FIG. 14 shows the message image 231 including a message indicating that a moving direction is not instructed but is not limited to this. The message image 231 may include a message indicating that a movement amount is not instructed. The message image 231 may include a message indicating that an instruction for at least one of a movement amount, a moving direction, and a movement target control point 215 is insufficient. The message image 231 may include a message indicating that a designated movement amount exceeds a movable amount. The message image 231 includes a message indicating that a voice instruction is insufficient or defective when the user performs voice instruction input. The message corresponds to an example of the information.

The movement instruction includes a moving direction and a movement amount of the selected control point 215s. When determining that the movement instruction does not include a moving direction or a movement amount, the display control device 40 causes the projector 20 to project a message indicating that instruction content is insufficient. That is, when determining that the movement instruction does not include a moving direction or a movement amount, the display control device 40 causes the projector 20 to project a message indicating that the instruction content is insufficient.

By checking the message image 231, the user can confirm that content input by the voice instruction input is insufficient.

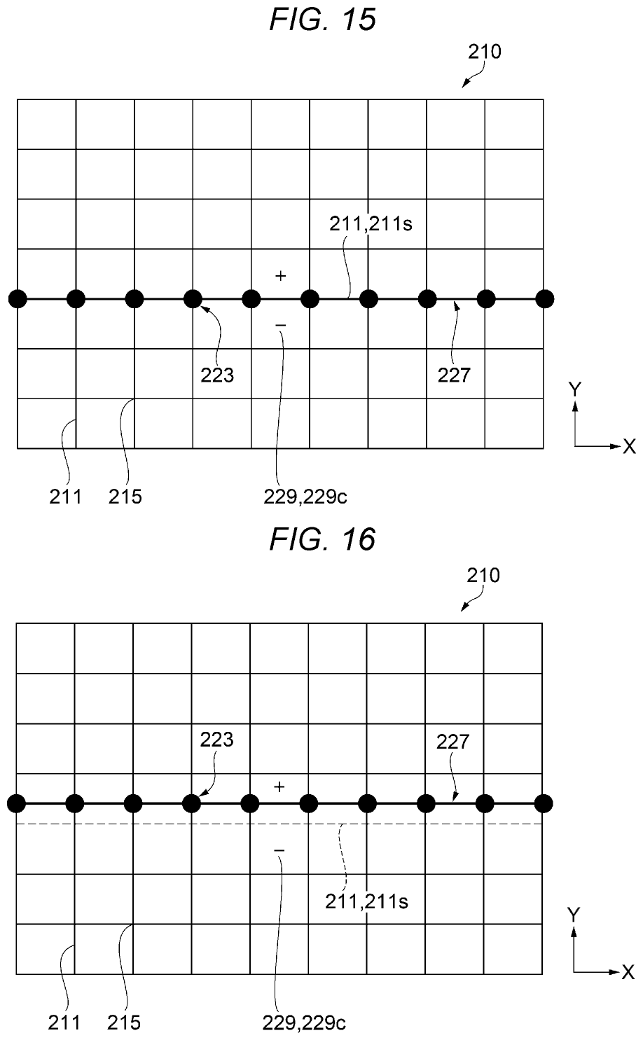

FIG. 15 enlarges and shows a part of the pattern image 210. FIG. 15 enlarges and shows a part of the first pattern image 210a, which is an example of the pattern image 210. The first pattern image 210a is projected onto the projection surface SC by the projecting unit 30. The projecting unit 30 projects the projection image 200 including the first pattern image 210a onto the projection surface SC. FIG. 15 shows the first pattern image 210a at the time when the user has selected the desired control line 211 as the selected control line 211s. FIG. 15 shows a part of the selected control line 211s. On the first pattern image 210a shown in FIG. 15, the control point images 223, the control line image 227, and a plurality of third direction instruction images 229c are displayed. The third direction instruction images 229c are an example of direction instruction images 229. The control point images 223 are the same as the control point image 223 shown in FIG. 7. The control line image 227 is the same as the control line image 227 shown in FIG. 9.

The third direction instruction images 229c indicate directions in which the selected control line 211s can move. Each of the plurality of third direction instruction images 229c indicates a direction with respect to the selected control line 211s. The plurality of third direction instruction images 229c are represented by “+” and “−”. As an example, “+” indicates the +Y direction with respect to the selected control line 211s.

When uttering a movement instruction for moving the selected control line 211s, the user utters a desired direction and a desired movement instruction amount in the plurality of third direction instruction images 229c. As an example, the user utters “move the line by five points in the plus direction”. “Plus” is an example of direction instruction voice for instructing a moving direction. “Five points” is an example of movement amount instruction voice for instructing a movement amount. “Move the line” is an example of movement instruction voice. The voice input unit 43 acquires voice including the direction instruction voice, the movement amount instruction voice, and the movement instruction voice. The voice input unit 43 transmits the voice to the voice processor 46. The voice processor 46 receives the voice. The voice processor 46 extracts a movement instruction included in the voice. The voice processor 46 generates, based on the voice, a movement instruction command for moving the selected control line 211s by five pixels in the +Y direction. The voice processor 46 transmits the movement instruction command to the executor 48 and the display controller 49.

FIG. 16 enlarges and shows a part of the pattern image 210. FIG. 16 enlarges and shows a part of the first pattern image 210a, which is an example of the pattern image 210. FIG. 16 shows the first pattern image 210a at the time when the user performs voice instruction input to the first pattern image 210a shown in FIG. 15. FIG. 16 shows a processing result at the time when the user utters voice “move the line by n points in the plus direction”. Here, n is any integer.

The voice input unit 43 acquires voice. The voice input unit 43 transmits the voice to the voice processor 46. The voice processor 46 receives the voice. The voice processor 46 extracts a movement instruction included in the voice. The voice processor 46 generates, based on the voice, a movement instruction command for moving the selected control line 211s by n pixels in the +Y direction. The voice processor 46 transmits the movement instruction command to the executor 48 and the display controller 49. The executor 48 receives the movement instruction command. The executor 48 performs processing based on the movement instruction command and causes the projector 20 to project the pattern image 210 shown in FIG. 16.

The selected control line 211s shown in FIG. 16 moves according to the movement instruction voice. The selected control line 211s moves to a position in the +Y direction according to the direction instruction voice. The selected control line 211s moves by n pixels in the +Y direction according to the movement instruction voice. By checking the third direction instruction images 229c, the user becomes capable of instructing a direction in which the selected control line 211s is moved. By uttering movement amount instruction voice, the user can designate a distance in which the selected control line 211s moves.

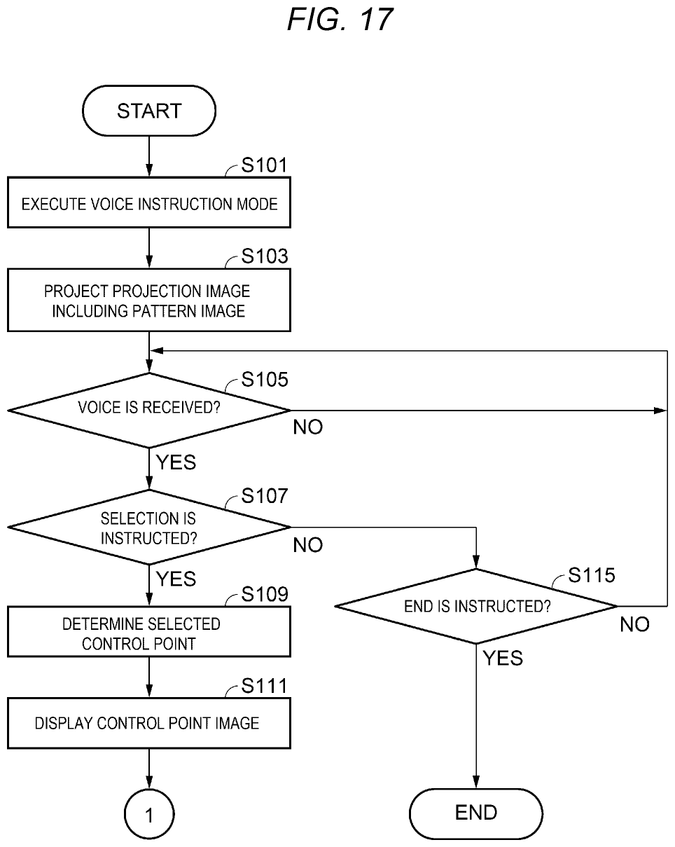

FIG. 17 shows a control flow of the display system 10. FIG. 17 shows a control flow executed by the display control device 40 of the first display system 10A. FIG. 17 shows the control flow as a flowchart. The display control device 40 becomes capable of executing the control flow shown in FIG. 17 by executing the image adjustment program AP. The control flow shown in FIG. 17 corresponds to an example of the projection method.

The display control device 40 executes the voice instruction mode in step S101. The display control device 40 executes the image adjustment program AP according to operation of the user. As an example, the user utters start voice including “start the program”. The voice input unit 43 of the display control device 40 acquires the start voice. The voice input unit 43 transmits the start voice to the control unit 45. The control unit 45 is triggered by the start voice to execute the image adjustment program AP. When the image adjustment program AP is started, the control unit 45 functions as the voice processor 46, the mode setter 47, the executor 48, and the display controller 49.

When the image adjustment program AP is executed by the start voice, the mode setter 47 sets the input mode to the voice instruction mode. When the mode setter 47 sets the input mode to the voice instruction mode, the control unit 45 becomes capable of executing the voice instruction mode. The user can perform voice instruction on the pattern image 210. The user becomes capable of adjusting the shape of the projection image 200 with voice.

The user may execute the image adjustment program AP using the input unit 53. The user performs predetermined operation using the input unit 53 to thereby execute the image adjustment program AP. After the image adjustment program AP is executed, the user performs the predetermined operation using the input unit 53, whereby the mode setter 47 sets the input mode to the voice instruction mode. The control unit 45 becomes capable of executing the voice instruction mode.

After executing the image adjustment program AP, in step S103, the display control device 40 causes the projector 20 to project the projection image 200. The display control device 40 causes the projector 20 to project the projection image 200 including the pattern image 210 onto the projection surface SC. The display control device 40 causes the projector 20 to project the first pattern image 210a shown in FIG. 5 or the second pattern image 210b shown in FIG. 6 as the pattern image 210 onto the projection surface SC. The display control device 40 causes the display 55 to display the management screen 100.

After causing the projector 20 to project the projection image 200 onto the projection surface SC, in step S105, the display control device 40 receives voice. The voice processor 46 of the control unit 45 detects voice of the user included in sound acquired by the voice input unit 43. The voice processor 46 discriminates whether an instruction is included in the voice of the user. When discriminating that the voice including an instruction has been acquired, the voice processor 46 proceeds to step S107 (YES in step S105). When discriminating that the voice including an instruction has not been acquired, the voice processor 46 continues the voice reception (NO in step S105).

After acquiring the voice including the instruction, in step S107, the display control device 40 discriminates whether the instruction included in the voice is a selection instruction. The voice processor 46 extracts the instruction included in the voice. When discriminating that the instruction included in the voice is the selection instruction, the voice processor 46 proceeds to step S109 (YES in step S107). When discriminating that the instruction included in the voice is not the selection instruction, the voice processor 46 proceeds to step S115 (NO in step S107). When discriminating that the instruction is the selection instruction, in step S109, the display control device 40 determines the selected control point 215s. The voice processor 46 generates a selection instruction command based on the voice. The voice processor 46 transmits the selection instruction command to the executor 48. The executor 48 determines the selected control point 215s using the selection instruction command. When the selection instruction command is an instruction to select the control line 211, the executor 48 determines the selected control line 211s.

After determining the selected control point 215s, in step S111, the display control device 40 causes the display 55 to display the control point image 223. The executor 48 causes the projector 20 to project the control point image 223 on the pattern image 210. The executor 48 causes the projector 20 to project the control point image 223 to thereby cause the display 55 to display the control point image 223 on the selected control point 215s. When the selected control line 211s is determined, the executor 48 causes the display 55 to display the region display image 225 or the control line image 227 on the pattern image 210.

When discriminating that the instruction is not the selection instruction, in step S115, the display control device 40 discriminates whether the instruction is an end instruction. The end instruction is an instruction for ending the processing for adjusting the shape of the projection image 200. When the display control device 40 discriminates that the instruction is the end instruction, the voice processor 46 ends the processing (YES in step S115). When the display control device 40 discriminates that the instruction is not the end instruction, the voice processor 46 returns the processing to step S105 (NO in step S115). The voice processor 46 continues the voice reception.

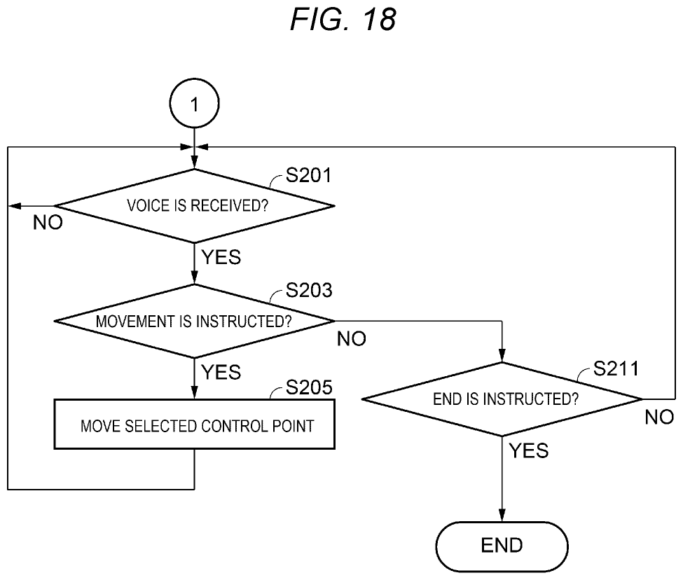

FIG. 18 shows a control flow of the display system 10. FIG. 18 shows a control flow executed in the display control device 40 of the first display system 10A. FIG. 18 shows the control flow as a flowchart. FIG. 18 shows a control flow after the control point image 223 is displayed in step S111 in FIG. 17.

After displaying the control point image 223, in step S201, the display control device 40 receives voice. The voice processor 46 detects voice of the user included in sound acquired by the voice input unit 43. The voice processor 46 discriminates whether an instruction is included in the voice of the user. When discriminating that the voice including an instruction has been acquired, the voice processor 46 proceeds to step S203 (YES in step S201). When discriminating that the voice including an instruction has not been acquired, the voice processor 46 continues the voice reception (NO in step S201).

After acquiring the voice including the instruction, in step S203, the display control device 40 discriminates whether the instruction included in the voice is a movement instruction. The voice processor 46 extracts the instruction included in the voice. When the display control device 40 discriminates that the instruction included in the voice is the movement instruction, the voice processor 46 proceeds to step S205 (YES in step S203). When the display control device 40 discriminates that the instruction included in the voice is not the movement instruction, the voice processor 46 proceeds to step S211 (NO in step S203).

When discriminating that the instruction is the movement instruction, in step S205, the display control device 40 moves the selected control point 215s. The voice processor 46 extracts a moving direction and a movement amount of the selected control point 215s included in the voice. The voice processor 46 generates a movement instruction command including the movement instruction, the moving direction, and the movement amount. The voice processor 46 transmits the movement instruction command to the executor 48. The executor 48 receives the movement instruction command. The executor 48 moves the selected control point 215s based on the movement instruction command. The executor 48 causes the projector 20 to project the pattern image 210 indicating a state in which the selected control point 215s has moved. When the display control device 40 discriminates that the instruction is the movement instruction for moving the selected control line 211s, the executor 48 moves the selected control line 211s. After moving the selected control line 211s, the executor 48 returns the processing to step S201.

When discriminating that the instruction is not the movement instruction, in step S211, the display control device 40 discriminates whether the instruction is the end instruction. When the display control device 40 discriminates that the instruction is the end instruction, the voice processor 46 ends the processing (YES in step S211). When the display control device 40 discriminates that the instruction is not the end instruction, the voice processor 46 returns the processing to step S201 (No in Step S211).

A projection method of the first display system 10A that projects the projection image 200 on to the projection surface SC includes executing a voice instruction mode for acquiring voice of a user and adjusting the shape of the projection image 200 based on an instruction included in the voice.

The user becomes capable of adjusting the shape of the projection image 200 with the voice.

The image adjustment program AP causes the display control device 40 to execute a voice instruction mode for acquiring voice of a user, extract an instruction included in the voice, and adjust the shape of the projection image 200 based on the extracted instruction.

The user becomes capable of adjusting the shape of the projection image 200 with the voice.

### Second Embodiment

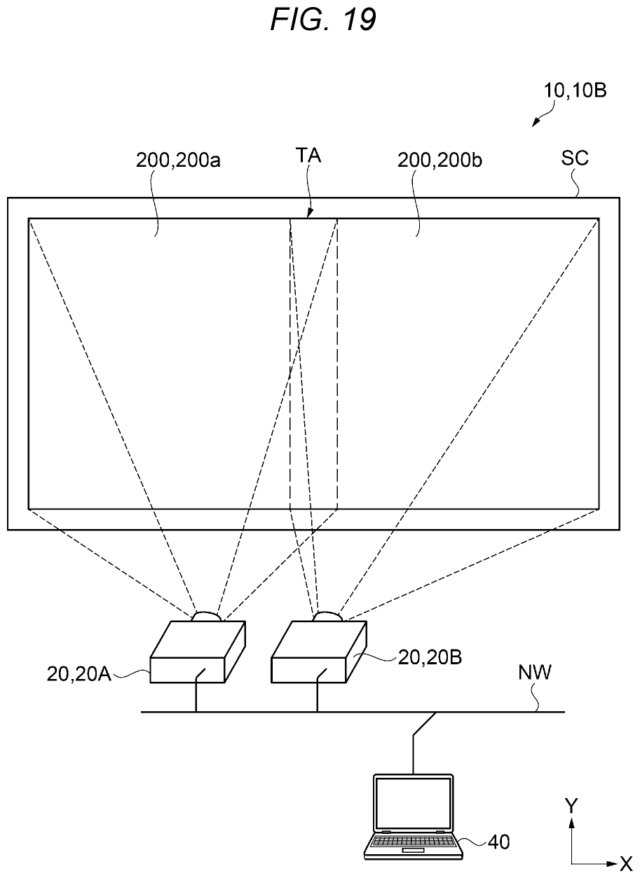

FIG. 19 shows a schematic configuration of the display system 10. FIG. 19 shows a schematic configuration of a second display system 10B in a second embodiment. The second display system 10B is an example of the display system 10. The second display system 10B includes a first projector 20A, a second projector 20B, and a display control device 40. The first projector 20A and the second projector 20B have the same configuration as the configuration of the projector 20 in the first embodiment. A configuration of the display control device 40 in the second embodiment is the same as the configuration of the display control device 40 in the first embodiment.

The first projector 20A projects a first projection image 200a onto the projection surface SC. The first projection image 200a is an example of the projection image 200. The first projector 20A is communicably connected to the display control device 40 via the network NW. When the display control device 40 executes the image adjustment program AP, the first projector 20A projects the first projection image 200a including the pattern image 210. The first projector 20A corresponds to an example of the projection device.

The second projector 20B projects a second projection image 200b onto the projection surface SC. The second projection image 200b is an example of the projection image 200. The second projector 20B is communicably connected to the display control device 40 via the network NW. When the display control device 40 executes the image adjustment program AP, the second projector 20B projects a second projection image 200b including the pattern image 210. The second projector 20B corresponds to an example of the projection device.

The first projector 20A and the second projector 20B project the first projection image 200a and the second projection image 200b onto the projection surface SC side by side. In FIG. 19, the first projection image 200a and the second projection image 200b are projected side by side along the X axis. The first projection image 200a and the second projection image 200b may be projected side by side along the Y axis. One of the first projection image 200a and the second projection image 200b includes the overlapping region TA overlapping a part of a region of the other. The display control device 40 transmits image data to the first projector 20A and the second projector 20B. The display control device 40 controls the first projector 20A and the second projector 20B based on the image data to project an image onto the projection surface SC. The display control device 40 projects one image onto the projection surface SC using the first projector 20A and the second projector 20B. The one image is formed by the first projection image 200a and the second projection image 200b.

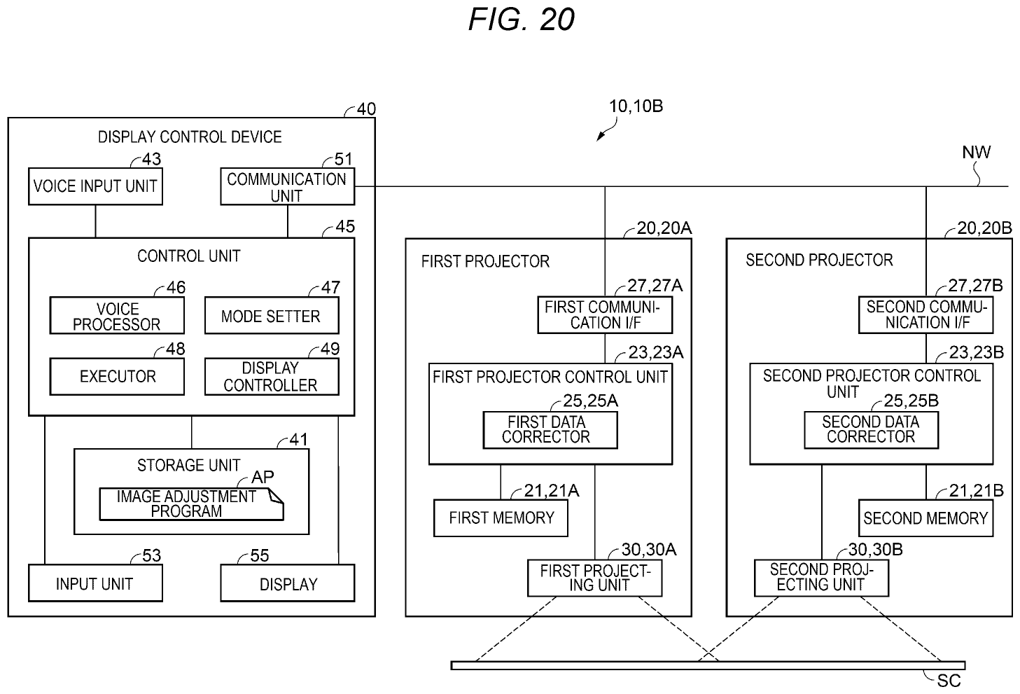

FIG. 20 shows a block configuration of the display system 10. FIG. 20 shows a block configuration of the second display system 10B. FIG. 20 shows the first projector 20A, the second projector 20B, and the display control device 40. FIG. 20 shows the projection surface SC onto which a projection image is projected by the first projector 20A and the second projector 20B.

The first projector 20A includes a first memory 21A, a first projector control unit 23A, a first communication interface 27A, and a first projecting unit 30A. In FIG. 20, interface is represented as I/F. The first memory 21A has the same configuration as the configuration of the memory 21 of the projector 20 shown in FIG. 2. The first projector control unit 23A has the same configuration as the configuration of the projector control unit 23 shown in FIG. 2. The first communication interface 27A has the same configuration as the configuration of the communication interface 27 shown in FIG. 2. The first projecting unit 30A has the same configuration as the configuration of the projecting unit 30 shown in FIG. 2. The first projector control unit 23A functions as a first data corrector 25A. The first data corrector 25A has the same function as the function of the data corrector 25 shown in FIG. 2.

The second projector 20B includes a second memory 21B, a second projector control unit 23B, a second communication interface 27B, and a second projecting unit 30B. The second memory 21B has the same configuration as the configuration of the memory 21 of the projector 20 shown in FIG. 2. The second projector control unit 23B has the same configuration as the configuration of the projector control unit 23 shown in FIG. 2. The second communication interface 27B has the same configuration as the configuration of the communication interface 27 shown in FIG. 2. The second projecting unit 30B has the same configuration as the configuration of the projecting unit 30 shown in FIG. 2. The second projector control unit 23B functions as a second data corrector 25B. The second data corrector 25B has the same function as the function of the data corrector 25 shown in FIG. 2.

The display control device 40 includes the storage unit 41, the voice input unit 43, the control unit 45, the communication unit 51, the input unit 53, and the display 55. Configurations of the units are the same as the configurations of the units of the display control device 40 shown in FIG. 2.

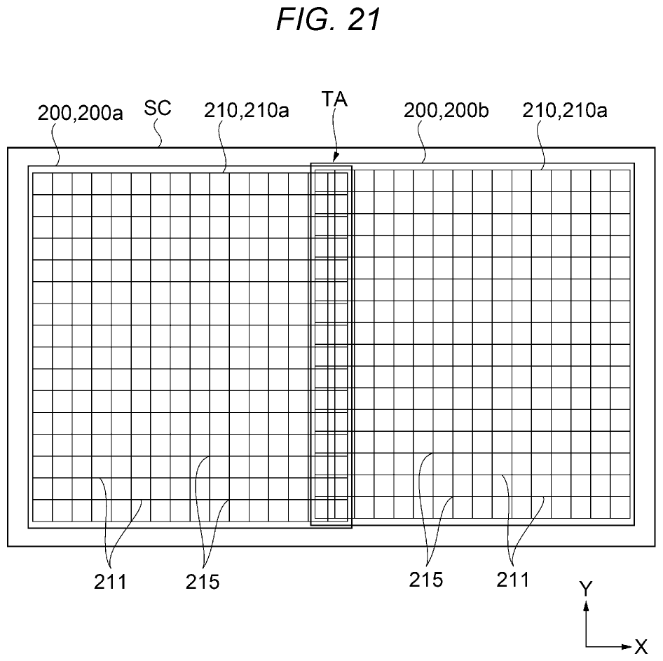

FIG. 21 shows an example of the projection image 200 projected onto the projection surface SC. FIG. 21 shows the first projection image 200a and the second projection image 200b. The first projection image 200a is projected onto the projection surface SC by the first projector 20A. FIG. 21 shows a state in which the first projection image 200a including the first pattern image 210a is projected onto the projection surface SC. The second projection image 200b is projected onto the projection surface SC by the second projector 20B. FIG. 21 shows a state in which the second projection image 200b including the first pattern image 210a is projected onto the projection surface SC. The first projection image 200a and the second projection image 200b are projected by the display control device 40 executing the image adjustment program AP.

The first projection image 200a and the second projection image 200b are projected in a state in which the first projection image 200a and the second projection image 200b include the overlapping region TA. In the overlapping region TA, the first pattern image 210a included in the first projection image 200a and the first pattern image 210a included in the second projection image 200b are displayed one on top of the other. A user can check deviation between the first projection image 200a and the second projection image 200b by checking the overlapping region TA. The user adjusts the shape of at least one of the first projection image 200a and the second projection image 200b by using the management screen 100. The user can perform edge blending. The user can make the deviation between the first projection image 200a and the second projection image 200b in the overlapping region TA less conspicuous by performing the edge blending.

The user adjusts the shape of at least one of the first projection image 200a and the second projection image 200b using the management screen 100. The user performs operation on a predetermined icon in the management screen 100 to thereby select the first projection image 200a or the second projection image 200b. As an example, the user selects the first projection image 200a. The user checks the first pattern image 210a included in the first projection image 200a. The user selects a desired control line 211 or a desired control point 215 in the first pattern image 210a. The user performs a movement instruction on the selected control line 211s or the selected control point 215s to thereby adjust the shape of the first projection image 200a.

When a plurality of projection images 200 are projected onto the projection surface SC, the user selects one of the plurality of projection images 200. The user checks the pattern image 210 included in the selected projection image 200. The user selects a desired control line 211 or a desired control point 215 in the pattern image 210. The user performs a movement instruction on the selected control line 211s or the selected control point 215s and corrects the shape of the pattern image 210. The user corrects the shape of the pattern image 210 to thereby adjust the shape of the projection image 200.

When the mode setter 47 of the display control device 40 sets a voice instruction mode as an input mode, the user can select one of the plurality of projection images 200 using voice. When the voice instruction mode is executable, the user utters voice including image instruction voice. The image instruction voice is voice for transmitting an image selection instruction for selecting one of the plurality of projection images 200 to be projected onto the projection surface SC. As shown in FIG. 21, when the first projection image 200a and the second projection image 200b are projected onto the projection surface SC, the image instruction voice is voice for transmitting the selection of the first projection image 200a or the second projection image 200b.

The voice input unit 43 acquires the voice including the image instruction voice. The voice input unit 43 transmits the voice including the image instruction voice to the voice processor 46. The voice processor 46 receives the voice. The voice processor 46 extracts the image selection instruction included in the voice. The image selection instruction corresponds to an example of the image selection command. The voice processor 46 generates an image selection command for selecting the first projection image 200a or the second projection image 200b. The voice processor 46 transmits the image selection command to the executor 48 and the display controller 49.

The display controller 49 receives the image selection command. The display controller 49 controls, based on the image selection command, the preview image 143 to be displayed on the management screen 100. When the image selection command is the image selection instruction for selecting the first projection image 200a, the display controller 49 causes the display window 141 to display the preview image 143 corresponding to the first pattern image 210a included in the first projection image 200a. The user can control, using the management screen 100, the control lines 211 or the control points 215 in the first pattern image 210a included in the first projection image 200a. When the mode setter 47 sets voice instruction input as the input mode, the control lines 211 or the control points 215 in the first pattern image 210a included in the first projection image 200a can be controlled by voice.

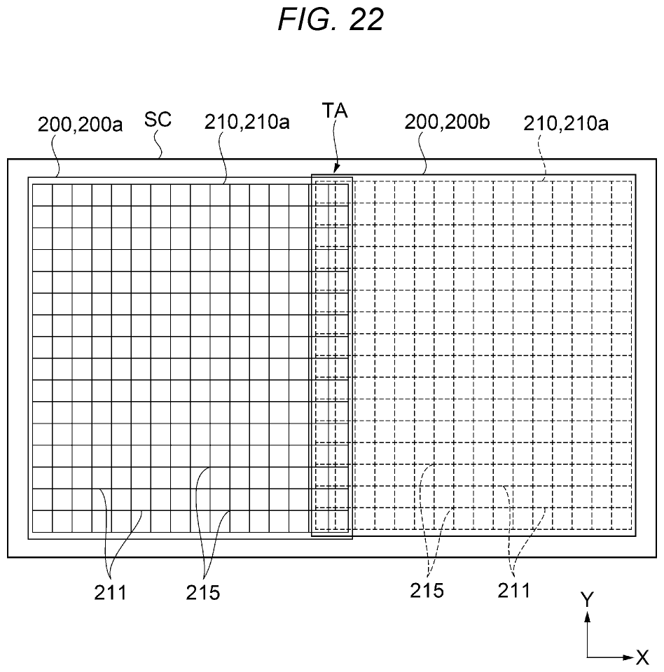

FIG. 22 shows an example of the projection image 200 projected onto the projection surface SC. FIG. 22 shows the first projection image 200a and the second projection image 200b. The first projection image 200a is projected onto the projection surface SC by the first projector 20A. The second projection image 200b is projected onto the projection surface SC by the second projector 20B. FIG. 22 shows the first projection image 200a including the first pattern image 210a and the second projection image 200b including the first pattern image 210a. FIG. 22 shows a state in which the first projection image 200a is selected by image instruction voice.

The first pattern image 210a included in the first projection image 200a is indicated by a solid line. The first pattern image 210a included in the second projection image 200b is indicated by a dotted line. The first projection image 200a is more easily visually recognizable for the user than the second projection image 200b. By checking the first projection image 200a and the second projection image 200b shown in FIG. 22, the user can grasp that the first projection image 200a is selected.

When receiving the image selection command, the executor 48 changes line types of the pattern images 210. By changing the line types, the executor 48 can cause the user to distinguish the first pattern image 210a included in the first projection image 200a and the first pattern image 210a included in the second projection image 200b. The executor 48 displays the first pattern image 210a included in the first projection image 200a in a line type more easily visually recognizable than the first pattern image 210a included in the second projection image 200b. By checking the line types, the user can confirm that the first projection image 200a is selected. The executor 48 controls the shapes of lines, the colors of the lines, the thicknesses of the lines, and the like as the line types. The executor 48 displays the pattern image 210 included in the projection image 200 selected by the image selection instruction in a darker color than the other pattern image 210. Alternatively, the executor 48 displays the pattern image 210 included in the projection image 200 selected by the image selection instruction in a thicker line than the other pattern image 210. The executor 48 may display, in red, the pattern image 210 included in the projection image 200 selected by the image selection instruction and display the other pattern image 210 in yellow.

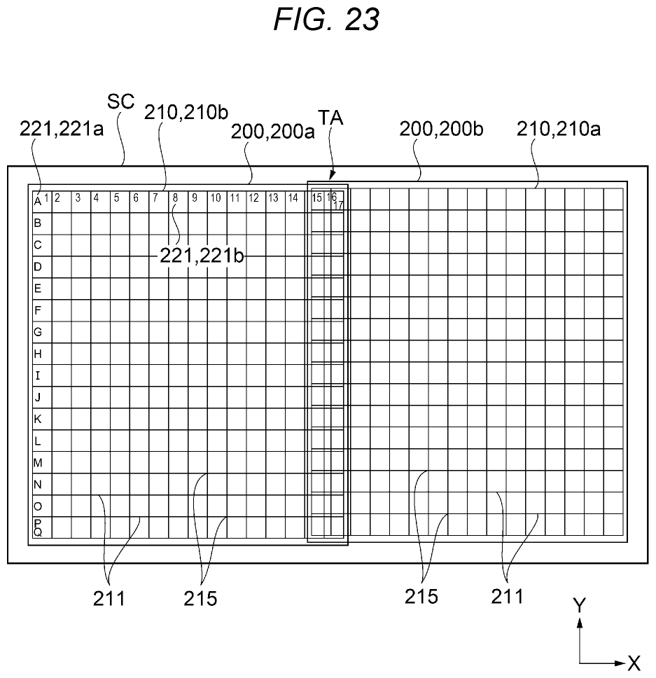

FIG. 23 shows an example of the projection image 200 projected onto the projection surface SC. FIG. 23 shows the first projection image 200a and the second projection image 200b. The first projection image 200a is projected onto the projection surface SC by the first projector 20A. The second projection image 200b is projected onto the projection surface SC by the second projector 20B. FIG. 23 shows a state in which the first projection image 200a is selected by image instruction voice. FIG. 23 shows the first projection image 200a including the second pattern image 210b and the second projection image 200b including the first pattern image 210a.

When the first projection image 200a is selected by the image selection instruction, the executor 48 causes the first projector 20A to project the first projection image 200a including the second pattern image 210b onto the projection surface SC. The second pattern image 210b includes the guide image 221. The user can select the control line 211 or the control point 215 using the guide image 221. On the other hand, the first pattern image 210a included in the second projection image 200b does not include the guide image 221. By checking the guide image 221, the user can confirm that the first projection image 200a is selected.

In FIG. 23, the first pattern image 210a included in the second projection image 200b is indicated by a solid line but is not limited to this. The executor 48 may display the first pattern image 210a included in the second projection image 200b in a form not easily visually recognized such as a dotted line as in FIG. 22. The user can more clearly confirm that the first projection image 200a is selected.

### Third Embodiment

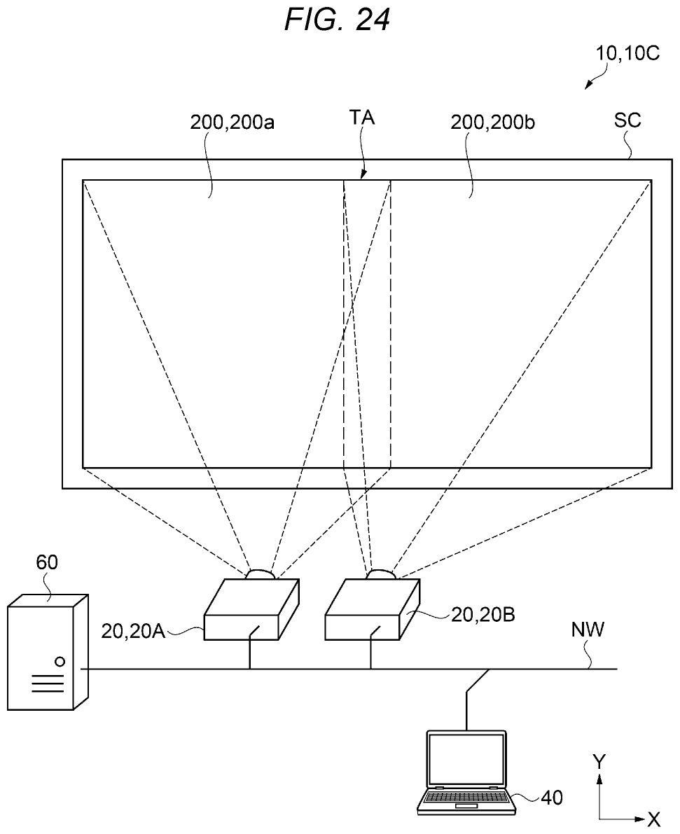

FIG. 24 shows a schematic configuration of the display system 10. FIG. 24 shows a schematic configuration of a third display system 10C in a third embodiment. The third display system 10C is an example of the display system 10. The third display system 10C includes the first projector 20A, the second projector 20B, the display control device 40, and a voice processing server 60. The first projector 20A and the second projector 20B have the same configuration as the configuration of the projector 20 in the first embodiment.

The voice processing server 60 is communicably connected to the display control device 40 via the network NW. The voice processing server 60 may be communicably connected to the first projector 20A and the second projector 20B via the network NW.

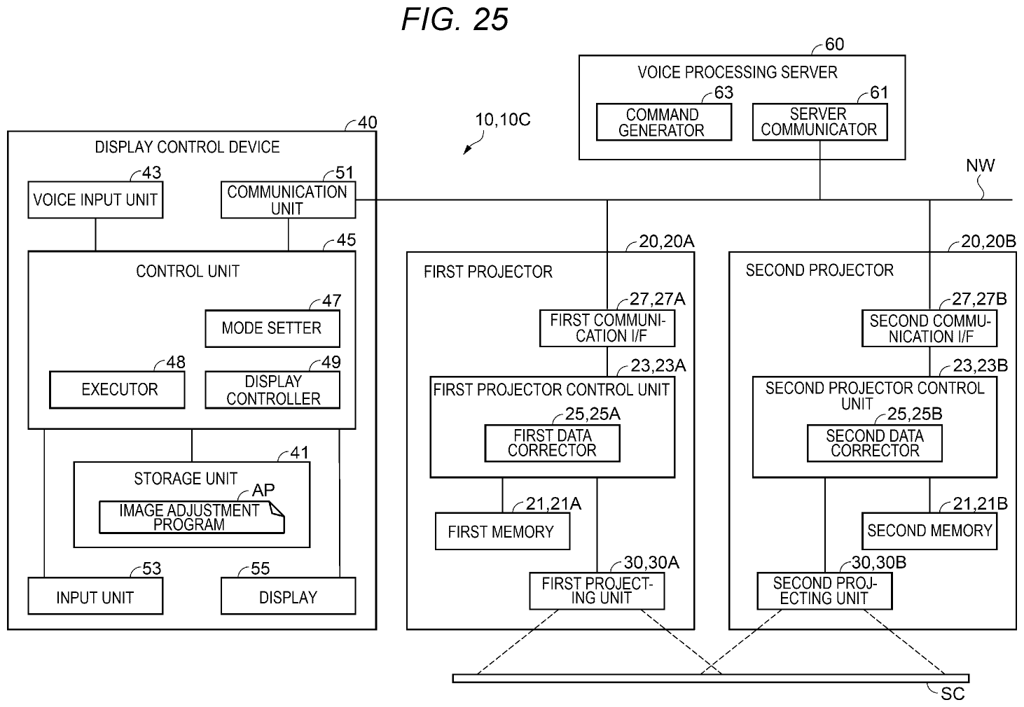

FIG. 25 shows a block configuration of the display system 10. FIG. 25 shows a block configuration of the third display system 10C. FIG. 25 shows the first projector 20A, the second projector 20B, the display control device 40, and the voice processing server 60. FIG. 25 shows the projection surface SC onto which projection images are projected by the first projector 20A and the second projector 20B.

A block configuration of the first projector 20A and the second projector 20B shown in FIG. 25 is the same as the block configuration of the first projector 20A and the second projector 20B shown in FIG. 20. A configuration of the display control device 40 shown in FIG. 25 is the same as the configuration of the display control device 40 shown in FIG. 20 except that the display control device 40 shown in FIG. 25 does not have the function of the voice processor 46 of the control unit 45 shown in FIG. 20.

The voice processing server 60 receives voice of the user transmitted from the display control device 40. The voice processing server 60 generates an instruction command based on the voice and transmits the instruction command to the display control device 40. The voice processing server 60 functions as a server communicator 61 and a command generator 63.

The server communicator 61 receives the voice of the user via the network NW. As an example, the server communicator 61 includes a connection port for wired communication, an antenna for wireless communication, and an interface circuit. The voice input unit 43 of the display control device 40 acquires voice of the user included in sound. The voice input unit 43 transmits the voice to the communication unit 51. The communication unit 51 transmits the voice to the server communicator 61 via the network NW. The server communicator 61 receives the voice transmitted from the communication unit 51. The server communicator 61 transmits the voice to the command generator 63.

The command generator 63 generates an instruction command based on an instruction included in the voice. The command generator 63 functions in the same manner as the voice processor 46 shown in FIG. 20. The command generator 63 extracts the instruction included in the voice. The command generator 63 converts the extracted instruction into an instruction command. The command generator 63 transmits the instruction command to the server communicator 61. The server communicator 61 receives the instruction command. The server communicator 61 transmits the instruction command to the communication unit 51 via the network NW. The communication unit 51 receives the instruction command. The communication unit 51 transmits the instruction command to the executor 48 and the display controller 49. The executor 48 adjusts, based on the instruction command, the shape of the projection image 200 to be projected onto the projection surface SC.

In FIG. 25, the voice of the user is acquired by the voice input unit 43 of the display control device 40 but is not limited to this. When the first projector 20A or the second projector 20B has a function of acquiring voice, the voice of the user may be acquired by the first projector 20A or the second projector 20B. The first projector 20A or the second projector 20B transmits the voice to the voice processing server 60 via the network NW.

### OTHER EMBODIMENTS

The first embodiment to the third embodiment explained above are preferred modes of implementations. However, embodiments are not limited to the first embodiment to the third embodiment. Various modified implementations are possible without departing from the gist.

In the first embodiment to the third embodiment, the point correction is executed. However, the embodiments are not limited to this.

For example, quick corner correction for correcting the shape of the projection image 200 may be executed in the voice instruction mode. In the quick corner correction, the shape of the projection image 200 is corrected by selecting and moving at least one of four corners that are correction targets. At this time, the display control device 40 or the voice processing server 60 may extract, as instructions included in voice of the user, a selection instruction, a movement instruction, a movement cancellation instruction, an end instruction, and the like for the correction target corner.

The display control device 40 or the voice processing server 60 may extract, as an instruction included in the voice of the user, a start instruction for instructing a start of projection of the pattern image 210. The display control device 40 may cause, according to the start instruction, the projector 20 to start projection of the pattern image 210. At this time, even if the start instruction is input to the voice input unit 43 in a period in which the content image CG is projected by the projector 20, it is preferable not to cause the projector 20 to project the pattern image 210. Consequently, it is possible to prevent the user from being hindered viewing the content image CG.

The projector 20 may have at least a part of the functions of the display control device 40 and at least a part of the functions of the voice processing server 60.

A summary of the present disclosure is noted below.

### Note 1

A projection system including: a projection device configured to project a projection image onto a projection target; a detection device configured to detect voice of a user; and a control device configured to control the projection device based on a command included in the voice detected by the detection device, wherein the control device is capable of executing a voice input mode for adjusting a shape of the projection image based on the command.

A user becomes capable of adjusting the shape of the projection image in the voice input mode.

### Note 2

The projection system described in Note 1, wherein the control device may cause the projection device to project, as the projection image, an adjustment image for adjusting the shape of the projection image, the adjustment image including a plurality of adjustment points, and may be capable of executing the voice input mode in a period in which the adjustment image is projected onto the projection target.

The user can perform an instruction by voice while checking the adjustment image including the plurality of adjustment points.

### Note 3

The projection system described in Note 2, wherein, when executing the voice input mode, the control device may cause the projection device to display a plurality of position information images indicating positions of the plurality of adjustment points on the adjustment image, and the command may include a selection command for selecting at least one of the plurality of adjustment points based on at least one of the plurality of position information images.

By referring to the position information image, the user can discriminate an adjustment point that the user desires to select.

### Note 4

The projection system described in Note 3, wherein, when at least one of the plurality of adjustment points is selected as a selection target according to the selection command, the control device may cause the projection device to project a selection display image indicating the selection target.

The user can check the position of the selection target.

### Note 5

The projection system described in any one of Notes 2 to 4, wherein the command may include a movement command for moving at least one of the plurality of adjustment points.

The user becomes capable of moving the adjustment point with voice.

### Note 6

The projection system described in Note 5, wherein the movement command may include a movement instruction direction and a movement amount of the adjustment point as instruction values, and, when determining that the movement command does not include the movement instruction direction or the movement amount, the control device may cause the projection device to project information indicating that the instruction values are insufficient.

By checking the information indicating that the instruction values are insufficient, the user can confirm that content input by voice is insufficient.

### Note 7

The projection system described in any one of Notes 2 to 6, wherein, when a correction instruction for correcting the projection image is included in the voice detected by the detection device, the control device may cause the projection device to project the projection image including the adjusted adjustment image.

The user can cause the projection device to project the adjustment image adjusted by the voice input mode onto the projection target. By checking the adjusted adjustment image, the user can determine whether an adjustment result is appropriate.

### Note 8

The projection system described in any one of Notes 2 to 7, further including a supply device configured to supply content data corresponding to a content image to the projection device, wherein the control device may not cause the projection device to project the adjustment image onto the projection target in a period in which the projection image including the content image is projected by the projection device.

The control device can prevent the projection image including the content image and the adjustment image from being projected onto the projection target. The user can easily visually recognize the content image or the adjustment image.

### Note 9

A projection method of a projection system that projects a projection image onto a projection target, the projection method including: executing a voice input mode for acquiring voice of a user; and adjusting a shape of the projection image based on a command included in the voice.

The user becomes capable of adjusting the shape of the projection image in the voice input mode.

A non-transitory computer-readable storage medium storing a projection program, the projection program causing a control device to: execute a voice input mode for acquiring voice of a user; extract a command included in the voice; and adjust a shape of a projection image based on the extracted command.

The user becomes capable of adjusting the shape of the projection image in the voice input mode.

What is claimed is:

1. A projection system comprising:
a projector configured to project a projection image onto a projection target;
a detector configured to detect voice of a user; and
a controller configured to control the projector based on a command included in the voice detected by the detector, wherein
the controller executes a voice input mode for adjusting a shape of the projection image based on the command.

2. The projection system according to claim 1, wherein the controller causes the projector to project, as the projection image, an adjustment image for adjusting the shape of the projection image, the adjustment image including a plurality of adjustment points, and executes the voice input mode in a period in which the adjustment image is projected onto the projection target.

3. The projection system according to claim 2, wherein
when executing the voice input mode, the controller causes the projector to display a plurality of position information images indicating positions of the plurality of adjustment points on the adjustment image, and
the command includes a selection command for selecting at least one of the plurality of adjustment points based on at least one of the plurality of position information images.

4. The projection system according to claim 3, wherein, when at least one of the plurality of adjustment points is selected as a selection target according to the selection command, the controller causes the projector to project a selection display image indicating the selection target.

5. The projection system according to claim 2, wherein the command includes a movement command for moving at least one of the plurality of adjustment points.

6. The projection system according to claim 5, wherein
the movement command includes a movement instruction direction and a movement amount of the adjustment point as instruction values, and
when determining that the movement command does not include the movement instruction direction or the movement amount, the controller causes the projector to project information indicating that the instruction values are insufficient.

7. The projection system according to claim 2, wherein
when a correction instruction for correcting the projection image is included in the voice detected by the detector, the controller causes the projector to project the projection image including the adjusted adjustment image.

8. The projection system according to claim 2, further comprising a supply device configured to supply content data corresponding to a content image to the projector, wherein
the controller does not cause the projector to project the adjustment image onto the projection target in a period in which the projection image including the content image is projected by the projector.

9. A projection method of a projection system that projects a projection image onto a projection target, the projection method comprising:
executing a voice input mode for acquiring voice of a user; and
adjusting a shape of the projection image based on a command included in the voice.

10. A non-transitory computer-readable storage medium storing a projection program, the projection program causing a controller to:
execute a voice input mode for acquiring voice of a user;
extract a command included in the voice; and
adjust a shape of a projection image based on the extracted command.
